(19) United States
(12) Patent Application Publication
(10) Pub. No.: US 2026/0072640 A1
(43) Pub. Date: Mar. 12, 2026

(54) SYSTEM

(71) Applicant: SoftBank Group Corp., Tokyo (JP)

(72) Inventor: Rui YANAGI, Tokyo (JP)

(21) Appl. No.: 19/317,425

(22) Filed: Sep. 3, 2025

(30) Foreign Application Priority Data
Sep. 10, 2024 (JP) 2024-155623

(51) Int. Cl. G06F 3/16; G06V 40/16; G10L 15/18; G10L 15/22

(52) U.S. Cl. CPC G06F 3/167; G06V 40/174; G10L 15/1815; G10L 15/22

(57) ABSTRACT

The system according to the embodiment comprises a voice collection unit, a facial expression collection unit, an analysis unit, an interpretation unit, a confidence evaluation unit, a presentation unit, and a voice guidance unit. The voice collection unit collects voice data. The facial expression collection unit collects facial expression data. The analysis unit analyzes data collected by the voice collection unit and the facial expression collection unit. The interpretation unit interprets the meaning and context of words based on the data analyzed by the analysis unit. The confidence evaluation unit evaluates the confidence of the interpretation results obtained by the interpretation unit. The presentation unit presents the interpretation results evaluated by the confidence evaluation unit to a smartphone. The voice guidance unit explains the interpretation results evaluated by the confidence evaluation unit via audio through earphones.

### CROSS-REFERENCE TO RELATED APPLICATION

The present application claims priority to and incorporates by reference the entire contents of Japanese Patent Application No. 2024-155623 filed in Japan on Sep. 10, 2024.

### BACKGROUND OF THE INVENTION

### Field of the Invention

The technology of this disclosure relates to a system.

### Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, it is difficult to accurately interpret the meaning and context of words based on voice and facial expression data, and there is room for improvement in providing highly reliable interpretation results.

### SUMMARY OF THE INVENTION

The system according to the embodiment comprises a voice collection unit, a facial expression collection unit, an analysis unit, an interpretation unit, a confidence evaluation unit, a presentation unit, and a voice guidance unit. The voice collection unit collects voice data. The facial expression collection unit collects facial expression data. The analysis unit analyzes data collected by the voice collection unit and the facial expression collection unit. The interpretation unit interprets the meaning and context of words based on the data analyzed by the analysis unit. The confidence evaluation unit evaluates the confidence of the interpretation results obtained by the interpretation unit. The presentation unit presents the interpretation results evaluated by the confidence evaluation unit to a smartphone. The voice guidance unit explains the interpretation results evaluated by the confidence evaluation unit via audio through earphones.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

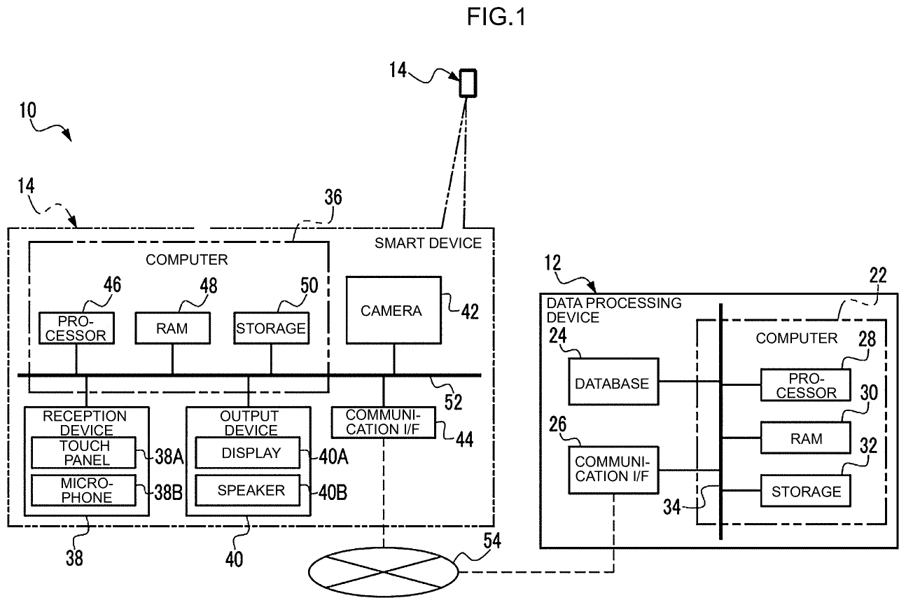

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

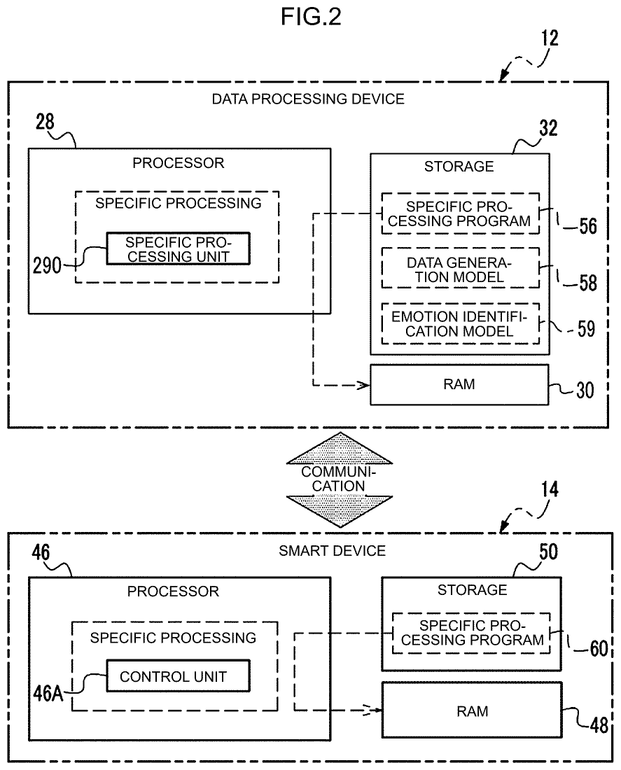

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of the Embodiment

The system according to the embodiment of the present invention is a system in which AI interprets the meaning and context of words from the voices heard and the facial expressions read from people, using earphones and glasses worn as wearable devices. In this system, the earphones first collect voice data, and the glasses collect facial expression data. Next, the AI analyzes these data and interprets the meaning and context of the words. The interpretation results are presented to the smartphone as several candidates together with their confidence, or explained via audio through the earphones. The AI can also determine how accurate what the person is saying is (i.e., whether they are lying). This system can also be used while traveling. For example, the earphones collect the voice of the conversation partner during a conversation and send the voice data to the AI. Next, the glasses capture the facial expression of the partner with a camera and send the data to the AI. Then, the AI analyzes the collected voice data and facial expression data. The AI extracts the meaning and context of words from the voice data and reads emotions and intentions from the facial expression data. For example, if the partner is speaking with a smile, the AI may determine that the words are likely a joke. The analysis results are presented to the smartphone as several interpretation candidates together with their confidence. For example, it may be displayed as “There is an 80% chance that these words are a joke.” The interpretation results may also be explained via audio through the earphones. For example, the voice guidance may say, “The partner is making a joke.” Furthermore, the AI can also determine how accurate what the person is saying is (i.e., whether they are lying). For example, the AI analyzes the tone of the partner's voice and changes in facial expression to determine whether there is a possibility of lying. This function can also be used while traveling, enabling smooth communication across language barriers. As a result, the user can accurately understand the meaning and context of the partner's words, improving the quality of communication. In addition, the function to detect lies enables the user to obtain highly reliable information. For example, when communicating with local people while traveling, using this system enables smooth communication across language barriers. Thus, the system allows the user to accurately understand the meaning and context of the partner's words and improve the quality of communication. In addition, the function to detect lies enables the user to obtain highly reliable information.

The interpretation system according to the embodiment comprises a voice collection unit, a facial expression collection unit, an analysis unit, an interpretation unit, a confidence evaluation unit, a presentation unit, and a voice guidance unit. The voice collection unit collects the voice of the conversation partner during a conversation. For example, the voice collection unit collects the partner's voice using a microphone and sends the voice data to the analysis unit. The voice collection unit can also use noise-canceling technology to remove ambient noise and collect clear voice data. For example, the voice collection unit analyzes ambient environmental sounds in real time and removes unnecessary sounds. The voice collection unit can also filter specific frequency bands to collect only conversation voice clearly. Furthermore, the voice collection unit can use multiple microphones to identify the direction of the sound source and collect only the target voice. The facial expression collection unit captures the facial expressions of the partner with a camera. For example, the facial expression collection unit uses a high-resolution camera to capture subtle facial movements and collect detailed facial expression data. The facial expression collection unit can individually analyze the movements of each part of the face (eyes, mouth, eyebrows, etc.) and estimate emotions and intentions. For example, the facial expression collection unit analyzes eye movements and blinking frequency to estimate emotions and intentions. The facial expression collection unit can also analyze mouth movements and the degree of smiling to estimate emotions and intentions. The analysis unit extracts the meaning and context of words from the voice data and reads emotions and intentions from the facial expression data. For example, the analysis unit uses natural language processing technology to analyze the voice data and extract the meaning and context of words. The analysis unit can also use facial expression recognition technology to analyze the facial expression data and read emotions and intentions. For example, the analysis unit calculates an emotion score based on changes in facial expression and estimates intentions. The interpretation unit generates several interpretation candidates based on the data analyzed by the analysis unit. For example, the interpretation unit generates multiple interpretation candidates based on the analysis results and evaluates the confidence of each. The confidence evaluation unit evaluates the confidence of the interpretation candidates. For example, the confidence evaluation unit calculates a confidence score for the interpretation candidates and evaluates the confidence using an evaluation algorithm. The presentation unit presents the interpretation results to the smartphone together with the confidence. For example, the presentation unit displays the interpretation results together with the confidence score on the smartphone screen. The voice guidance unit explains the interpretation results via audio through earphones. For example, the voice guidance unit uses speech synthesis technology to explain the interpretation results via audio and guide the user. Thus, the interpretation system according to the embodiment enables the user to accurately understand the meaning and context of the partner's words and improve the quality of communication.

The voice collection unit can collect the voice of the conversation partner during a conversation. For example, the voice collection unit collects the partner's voice using a microphone and sends the voice data to the analysis unit. The voice collection unit can also use noise-canceling technology to remove ambient noise and collect clear voice data. For example, the voice collection unit analyzes ambient environmental sounds in real time and removes unnecessary sounds. The voice collection unit can also filter specific frequency bands to collect only conversation voice clearly. Furthermore, the voice collection unit can use multiple microphones to identify the direction of the sound source and collect only the target voice. By collecting the voice of the conversation partner during a conversation, it is possible to obtain voice data in real time. Some or all of the above-described processing in the voice collection unit may be performed using AI, or may be performed without using AI. For example, the voice collection unit can input the voice data obtained by the microphone to a generative AI and have the generative AI perform the analysis of the voice data.

The facial expression collection unit can capture the facial expressions of the partner with a camera. For example, the facial expression collection unit captures the facial expressions of the partner with a high-resolution camera and sends the facial expression data to the analysis unit. The facial expression collection unit can individually analyze the movements of each part of the face (eyes, mouth, eyebrows, etc.) and estimate emotions and intentions. For example, the facial expression collection unit analyzes eye movements and blinking frequency to estimate emotions and intentions. The facial expression collection unit can also analyze mouth movements and the degree of smiling to estimate emotions and intentions. By capturing the facial expressions of the partner with a camera, it is possible to collect facial expression data. Some or all of the above-described processing in the facial expression collection unit may be performed using AI, or may be performed without using AI. For example, the facial expression collection unit can input the facial expression data obtained by the camera to a generative AI and have the generative AI perform the analysis of the facial expression data.

The analysis unit can extract the meaning and context of words from the voice data and analyze emotions and intentions from the facial expression data. For example, the analysis unit analyzes the voice data using natural language processing technology to extract the meaning and context of words. The analysis unit can also use facial expression recognition technology to analyze the facial expression data and read emotions and intentions. For example, the analysis unit calculates an emotion score based on changes in facial expression and estimates intentions. By analyzing the voice data and facial expression data, it is possible to accurately grasp the meaning and context of words, as well as emotions and intentions. Some or all of the above-described processing in the analysis unit may be performed using AI, or may be performed without using AI. For example, the analysis unit can input the voice data and facial expression data to a generative AI and have the generative AI perform the analysis of the data.

The interpretation unit can generate several interpretation candidates based on the data analyzed by the analysis unit. For example, the interpretation unit generates multiple interpretation candidates based on the analysis results and evaluates the confidence of each. The interpretation unit sends the generated interpretation candidates together with their confidence scores to the presentation unit. By generating multiple interpretation candidates, the range of interpretation is broadened, enabling more accurate interpretation. Some or all of the above-described processing in the interpretation unit may be performed using AI, or may be performed without using AI. For example, the interpretation unit can input the analysis results to a generative AI and have the generative AI generate the interpretation candidates.

The confidence evaluation unit can evaluate the confidence of the interpretation candidates. For example, the confidence evaluation unit calculates a confidence score for the interpretation candidates and evaluates the confidence using an evaluation algorithm. The confidence evaluation unit sends the evaluation results to the presentation unit and the voice guidance unit. By evaluating the confidence of the interpretation candidates, it is possible to provide the user with highly reliable interpretation results. Some or all of the above-described processing in the confidence evaluation unit may be performed using AI, or may be performed without using AI. For example, the confidence evaluation unit can input the confidence scores of the interpretation candidates to a generative AI and have the generative AI perform the confidence evaluation.

The presentation unit can present the interpretation results to the smartphone together with the confidence. For example, the presentation unit displays the interpretation results together with the confidence score on the smartphone screen. The presentation unit visually presents the interpretation results through the user interface, making it easier for the user to judge the reliability of the interpretation results. By presenting the interpretation results together with the confidence, it becomes easier for the user to judge the reliability of the interpretation results. Some or all of the above-described processing in the presentation unit may be performed using AI, or may be performed without using AI. For example, the presentation unit can input the interpretation results and confidence scores to a generative AI and have the generative AI optimize the presentation method.

The voice guidance unit can explain the interpretation results via audio through earphones. For example, the voice guidance unit uses speech synthesis technology to explain the interpretation results via audio and guide the user. The voice guidance unit explains the interpretation results together with the confidence score via audio, allowing the user to understand the interpretation results without relying on visual information. By explaining the interpretation results via audio, the user can understand the interpretation results without relying on visual information. Some or all of the above-described processing in the voice guidance unit may be performed using AI, or may be performed without using AI. For example, the voice guidance unit can input the interpretation results and confidence scores to a generative AI and have the generative AI optimize the voice guidance.

The confidence evaluation unit can analyze the tone of the partner's voice and changes in facial expression to determine whether the partner is lying. For example, the confidence evaluation unit analyzes the tone of the partner's voice to determine the possibility of lying. The confidence evaluation unit can also analyze changes in facial expression to determine the possibility of lying. For example, the confidence evaluation unit determines whether the partner is lying based on changes in the tone of the voice and changes in facial expression. By analyzing the tone of the partner's voice and changes in facial expression, it is possible to determine the possibility of lying. Some or all of the above-described processing in the confidence evaluation unit may be performed using AI, or may be performed without using AI. For example, the confidence evaluation unit can input the tone of the voice and changes in facial expression to a generative AI and have the generative AI perform lie detection.

The voice collection unit can filter ambient environmental sounds to remove noise during voice collection. For example, the voice collection unit analyzes ambient noise in real time and removes unnecessary sounds using noise-canceling technology. The voice collection unit can also filter specific frequency bands to collect only conversation voice clearly. For example, the voice collection unit can use multiple microphones to identify the direction of the sound source and collect only the target voice. By filtering ambient environmental sounds to remove noise, it is possible to collect clear voice data. Some or all of the above-described processing in the voice collection unit may be performed using AI, or may be performed without using AI. For example, the voice collection unit can input environmental sound data to a generative AI and have the generative AI perform noise removal.

The voice collection unit can prioritize the collection of relevant voice data by considering the user's geographic location during voice collection. For example, when the user is in a specific location, the voice collection unit prioritizes the collection of conversations related to that location. When the user is moving, the voice collection unit can prioritize the collection of conversations containing information related to the destination. For example, when the user is at a tourist spot, the voice collection unit prioritizes the collection of conversations related to the history and culture of that place. By considering the user's geographic location, it is possible to prioritize the collection of relevant voice data. Some or all of the above-described processing in the voice collection unit may be performed using AI, or may be performed without using AI. For example, the voice collection unit can input geographic location information to a generative AI and have the generative AI perform the collection of relevant voice data.

The voice collection unit can analyze the user's social media activity during voice collection and collect relevant voice data. For example, the voice collection unit analyzes the user's social media posts and prioritizes the collection of relevant conversations. The voice collection unit can also collect relevant voice data based on information from accounts followed by the user. For example, the voice collection unit considers the user's active time on social media and collects voice data relevant to that time period. By analyzing the user's social media activity, it is possible to collect relevant voice data. Some or all of the above-described processing in the voice collection unit may be performed using AI, or may be performed without using AI. For example, the voice collection unit can input social media data to a generative AI and have the generative AI perform the collection of relevant voice data.

The facial expression collection unit can use a high-resolution camera to capture subtle facial movements during facial expression collection. For example, the facial expression collection unit uses a high-resolution camera to capture subtle facial movements and collect detailed facial expression data. The facial expression collection unit can capture subtle movements of each part of the face (eyes, mouth, eyebrows, etc.) with a high-resolution camera and send them to the analysis unit. For example, the facial expression collection unit collects subtle facial movements in real time and sends them to the analysis unit. By using a high-resolution camera, it is possible to collect subtle facial movements in detail. Some or all of the above-described processing in the facial expression collection unit may be performed using AI, or may be performed without using AI. For example, the facial expression collection unit can input facial expression data obtained by the high-resolution camera to a generative AI and have the generative AI analyze the subtle movements.

The facial expression collection unit can individually analyze the movements of each part of the face during facial expression collection. For example, the facial expression collection unit individually analyzes the movements of each part of the face (eyes, mouth, eyebrows, etc.) and collects detailed facial expression data. The facial expression collection unit can also analyze eye movements and blinking frequency to estimate emotions and intentions. For example, the facial expression collection unit analyzes mouth movements and the degree of smiling to estimate emotions and intentions. By individually analyzing the movements of each part of the face, it is possible to collect detailed facial expression data. Some or all of the above-described processing in the facial expression collection unit may be performed using AI, or may be performed without using AI. For example, the facial expression collection unit can input movement data of each part of the face to a generative AI and have the generative AI analyze the movements.

The facial expression collection unit can prioritize the collection of relevant facial expressions by considering the user's geographic location during facial expression collection. For example, when the user is in a specific location, the facial expression collection unit prioritizes the collection of facial expressions related to that location. When the user is moving, the facial expression collection unit can prioritize the collection of facial expressions containing information related to the destination. For example, when the user is at a tourist spot, the facial expression collection unit prioritizes the collection of facial expressions related to the history and culture of that place. By considering the user's geographic location, it is possible to prioritize the collection of relevant facial expressions. Some or all of the above-described processing in the facial expression collection unit may be performed using AI, or may be performed without using AI. For example, the facial expression collection unit can input geographic location information to a generative AI and have the generative AI perform the collection of relevant facial expressions.

The facial expression collection unit can analyze the user's social media activity during facial expression collection and collect relevant facial expressions. For example, the facial expression collection unit analyzes the user's social media posts and prioritizes the collection of relevant facial expressions. The facial expression collection unit can also collect relevant facial expressions based on information from accounts followed by the user. For example, the facial expression collection unit considers the user's active time on social media and collects facial expressions relevant to that time period. By analyzing the user's social media activity, it is possible to collect relevant facial expressions. Some or all of the above-described processing in the facial expression collection unit may be performed using AI, or may be performed without using AI. For example, the facial expression collection unit can input social media data to a generative AI and have the generative AI perform the collection of relevant facial expressions.

The analysis unit can improve analysis accuracy by considering the interrelationship between voice data and facial expression data during analysis. For example, the analysis unit synchronizes the timing of voice data and facial expression data and analyzes their interrelationship. The analysis unit can also combine the tone of the voice data and changes in the facial expression data for analysis. For example, the analysis unit integrates the content of the voice data and the emotion of the facial expression data for analysis. By considering the interrelationship between voice data and facial expression data, analysis accuracy is improved. Some or all of the above-described processing in the analysis unit may be performed using AI, or may be performed without using AI. For example, the analysis unit can input voice data and facial expression data to a generative AI and have the generative AI analyze the interrelationship.

The analysis unit can optimize the analysis algorithm by referring to past data during analysis. For example, the analysis unit refers to past conversation data to optimize the analysis algorithm. The analysis unit can also refer to past facial expression data to optimize the analysis algorithm. For example, the analysis unit refers to past correlation data between voice and facial expressions to optimize the analysis algorithm. By referring to past data, the analysis algorithm can be optimized. Some or all of the above-described processing in the analysis unit may be performed using AI, or may be performed without using AI. For example, the analysis unit can input past data to a generative AI and have the generative AI optimize the analysis algorithm.

The analysis unit can perform analysis by considering the geographic distribution of voice data and facial expression data during analysis. For example, the analysis unit considers the collection locations of voice data and facial expression data and analyzes the geographic distribution. The analysis unit can also analyze patterns of voice and facial expressions in specific regions. For example, the analysis unit adjusts the analysis algorithm based on the geographic distribution. By considering the geographic distribution of voice data and facial expression data, more accurate analysis is possible. Some or all of the above-described processing in the analysis unit may be performed using AI, or may be performed without using AI. For example, the analysis unit can input geographic distribution data to a generative AI and have the generative AI perform the analysis.

The analysis unit can improve analysis accuracy by referring to related literature during analysis. For example, the analysis unit refers to the latest research papers to improve the analysis algorithm. The analysis unit can also refer to related patent literature to optimize the analysis method. For example, the analysis unit refers to past research data to improve analysis accuracy. By referring to related literature, analysis accuracy is improved. Some or all of the above-described processing in the analysis unit may be performed using AI, or may be performed without using AI. For example, the analysis unit can input related literature data to a generative AI and have the generative AI improve analysis accuracy.

The interpretation unit can improve interpretation accuracy by considering the interrelationship between voice data and facial expression data during interpretation. For example, the interpretation unit synchronizes the timing of voice data and facial expression data and interprets their interrelationship. The interpretation unit can also combine the tone of the voice data and changes in the facial expression data for interpretation. For example, the interpretation unit integrates the content of the voice data and the emotion of the facial expression data for interpretation. By considering the interrelationship between voice data and facial expression data, interpretation accuracy is improved. Some or all of the above-described processing in the interpretation unit may be performed using AI, or may be performed without using AI. For example, the interpretation unit can input voice data and facial expression data to a generative AI and have the generative AI interpret the interrelationship.

The interpretation unit can optimize the interpretation algorithm by referring to past data during interpretation. For example, the interpretation unit refers to past conversation data to optimize the interpretation algorithm. The interpretation unit can also refer to past facial expression data to optimize the interpretation algorithm. For example, the interpretation unit refers to past correlation data between voice and facial expressions to optimize the interpretation algorithm. By referring to past data, the interpretation algorithm can be optimized. Some or all of the above-described processing in the interpretation unit may be performed using AI, or may be performed without using AI. For example, the interpretation unit can input past data to a generative AI and have the generative AI optimize the interpretation algorithm.

The interpretation unit can perform interpretation by considering the geographic distribution of voice data and facial expression data during interpretation. For example, the interpretation unit considers the collection locations of voice data and facial expression data and interprets the geographic distribution. The interpretation unit can also interpret patterns of voice and facial expressions in specific regions. For example, the interpretation unit adjusts the interpretation algorithm based on the geographic distribution. By considering the geographic distribution of voice data and facial expression data, more accurate interpretation is possible. Some or all of the above-described processing in the interpretation unit may be performed using AI, or may be performed without using AI. For example, the interpretation unit can input geographic distribution data to a generative AI and have the generative AI perform the interpretation.

The interpretation unit can improve interpretation accuracy by referring to related literature during interpretation. For example, the interpretation unit refers to the latest research papers to improve the interpretation algorithm. The interpretation unit can also refer to related patent literature to optimize the interpretation method. For example, the interpretation unit refers to past research data to improve interpretation accuracy. By referring to related literature, interpretation accuracy is improved. Some or all of the above-described processing in the interpretation unit may be performed using AI, or may be performed without using AI. For example, the interpretation unit can input related literature data to a generative AI and have the generative AI improve interpretation accuracy.

The confidence evaluation unit can improve the accuracy of confidence by considering the interrelationship between voice data and facial expression data during confidence evaluation. For example, the confidence evaluation unit synchronizes the timing of voice data and facial expression data and evaluates their interrelationship. The confidence evaluation unit can also combine the tone of the voice data and changes in the facial expression data for evaluation. For example, the confidence evaluation unit integrates the content of the voice data and the emotion of the facial expression data for evaluation. By considering the interrelationship between voice data and facial expression data, the accuracy of confidence is improved. Some or all of the above-described processing in the confidence evaluation unit may be performed using AI, or may be performed without using AI. For example, the confidence evaluation unit can input voice data and facial expression data to a generative AI and have the generative AI evaluate the interrelationship.

The confidence evaluation unit can optimize the confidence evaluation algorithm by referring to past data during confidence evaluation. For example, the confidence evaluation unit refers to past conversation data to optimize the confidence evaluation algorithm. The confidence evaluation unit can also refer to past facial expression data to optimize the confidence evaluation algorithm. For example, the confidence evaluation unit refers to past correlation data between voice and facial expressions to optimize the confidence evaluation algorithm. By referring to past data, the confidence evaluation algorithm can be optimized. Some or all of the above-described processing in the confidence evaluation unit may be performed using AI, or may be performed without using AI. For example, the confidence evaluation unit can input past data to a generative AI and have the generative AI optimize the confidence evaluation algorithm.

The confidence evaluation unit can perform confidence evaluation by considering the geographic distribution of voice data and facial expression data during confidence evaluation. For example, the confidence evaluation unit considers the collection locations of voice data and facial expression data and evaluates the geographic distribution. The confidence evaluation unit can also evaluate patterns of voice and facial expressions in specific regions. For example, the confidence evaluation unit adjusts the confidence evaluation algorithm based on the geographic distribution. By considering the geographic distribution of voice data and facial expression data, more accurate confidence evaluation is possible. Some or all of the above-described processing in the confidence evaluation unit may be performed using AI, or may be performed without using AI. For example, the confidence evaluation unit can input geographic distribution data to a generative AI and have the generative AI perform the confidence evaluation.

The confidence evaluation unit can improve the accuracy of confidence evaluation by referring to related literature during confidence evaluation. For example, the confidence evaluation unit refers to the latest research papers to improve the confidence evaluation algorithm. The confidence evaluation unit can also refer to related patent literature to optimize the confidence evaluation method. For example, the confidence evaluation unit refers to past research data to improve the accuracy of confidence evaluation. By referring to related literature, the accuracy of confidence evaluation is improved. Some or all of the above-described processing in the confidence evaluation unit may be performed using AI, or may be performed without using AI. For example, the confidence evaluation unit can input related literature data to a generative AI and have the generative AI improve the accuracy of confidence evaluation.

The presentation unit can adjust the level of detail of the presentation based on the importance of the interpretation results during presentation. For example, the presentation unit displays important interpretation results in detail to make them easier for the user to understand. The presentation unit can also display less important interpretation results concisely to reduce the user's burden. For example, the presentation unit dynamically adjusts the display content according to the importance of the interpretation results. By adjusting the level of detail of the presentation based on the importance of the interpretation results, important information can be prioritized for the user. Some or all of the above-described processing in the presentation unit may be performed using AI, or may be performed without using AI. For example, the presentation unit can input importance data of the interpretation results to a generative AI and have the generative AI adjust the level of detail of the presentation.

The presentation unit can apply different presentation algorithms according to the category of the interpretation results during presentation. For example, the presentation unit visually displays interpretation results related to emotions to allow the user to intuitively understand them. The presentation unit can also display interpretation results related to context as text to provide detailed information. For example, the presentation unit displays interpretation results related to confidence as graphs to show reliability to the user. By applying different presentation algorithms according to the category of the interpretation results, optimal display for the user is possible. Some or all of the above-described processing in the presentation unit may be performed using AI, or may be performed without using AI. For example, the presentation unit can input category data of the interpretation results to a generative AI and have the generative AI apply the presentation algorithm.

The presentation unit can determine the priority of the presentation based on the submission timing of the interpretation results during presentation. For example, the presentation unit prioritizes the display of the latest interpretation results to provide information to the user quickly. The presentation unit can also display past interpretation results concisely to reduce the user's burden. For example, the presentation unit dynamically adjusts the display content according to the submission timing of the interpretation results. By determining the priority of the presentation based on the submission timing of the interpretation results, the latest information can be provided quickly. Some or all of the above-described processing in the presentation unit may be performed using AI, or may be performed without using AI. For example, the presentation unit can input submission timing data of the interpretation results to a generative AI and have the generative AI determine the priority of the presentation.

The presentation unit can adjust the order of the presentation based on the relevance of the interpretation results during presentation. For example, the presentation unit prioritizes the display of highly relevant interpretation results to provide important information to the user. The presentation unit can also display less relevant interpretation results concisely to reduce the user's burden. For example, the presentation unit dynamically adjusts the display content according to the relevance of the interpretation results. By adjusting the order of the presentation based on the relevance of the interpretation results, important information can be prioritized for the user. Some or all of the above-described processing in the presentation unit may be performed using AI, or may be performed without using AI. For example, the presentation unit can input relevance data of the interpretation results to a generative AI and have the generative AI adjust the order of the presentation.

The voice guidance unit can adjust the level of detail of the guidance based on the importance of the interpretation results during voice guidance. For example, the voice guidance unit explains important interpretation results in detail to make them easier for the user to understand. The voice guidance unit can also explain less important interpretation results concisely to reduce the user's burden. For example, the voice guidance unit dynamically adjusts the guidance content according to the importance of the interpretation results. By adjusting the level of detail of the guidance based on the importance of the interpretation results, important information can be prioritized for the user. Some or all of the above-described processing in the voice guidance unit may be performed using AI, or may be performed without using AI. For example, the voice guidance unit can input importance data of the interpretation results to a generative AI and have the generative AI adjust the level of detail of the guidance.

The voice guidance unit can apply different guidance algorithms according to the category of the interpretation results during voice guidance. For example, the voice guidance unit visually explains interpretation results related to emotions to allow the user to intuitively understand them. The voice guidance unit can also explain interpretation results related to context as text to provide detailed information. For example, the voice guidance unit explains interpretation results related to confidence as graphs to show reliability to the user. By applying different guidance algorithms according to the category of the interpretation results, optimal guidance for the user is possible. Some or all of the above-described processing in the voice guidance unit may be performed using AI, or may be performed without using AI. For example, the voice guidance unit can input category data of the interpretation results to a generative AI and have the generative AI apply the guidance algorithm.

The voice guidance unit can determine the priority of the guidance based on the submission timing of the interpretation results during voice guidance. For example, the voice guidance unit prioritizes the guidance of the latest interpretation results to provide information to the user quickly. The voice guidance unit can also provide concise guidance for past interpretation results to reduce the user's burden. For example, the voice guidance unit dynamically adjusts the guidance content according to the submission timing of the interpretation results. By determining the priority of the guidance based on the submission timing of the interpretation results, the latest information can be provided quickly. Some or all of the above-described processing in the voice guidance unit may be performed using AI, or may be performed without using AI. For example, the voice guidance unit can input submission timing data of the interpretation results to a generative AI and have the generative AI determine the priority of the guidance.

The voice guidance unit can adjust the order of the guidance based on the relevance of the interpretation results during voice guidance. For example, the voice guidance unit prioritizes the guidance of highly relevant interpretation results to provide important information to the user. The voice guidance unit can also provide concise guidance for less relevant interpretation results to reduce the user's burden. For example, the voice guidance unit dynamically adjusts the guidance content according to the relevance of the interpretation results. By adjusting the order of the guidance based on the relevance of the interpretation results, important information can be prioritized for the user. Some or all of the above-described processing in the voice guidance unit may be performed using AI, or may be performed without using AI. For example, the voice guidance unit can input relevance data of the interpretation results to a generative AI and have the generative AI adjust the order of the guidance.

The system according to the embodiment is not limited to the above-described examples and can be variously modified as follows, for example.

The interpretation system may further comprise a history reference unit that refers to the user's past conversation history. The history reference unit provides past conversation data to the analysis unit, which can use this data to more accurately interpret the context of the current conversation. For example, if the user has previously discussed a specific topic, when a new conversation related to that topic occurs, the system can refer to past information to improve interpretation accuracy. In addition, the history reference unit can also record the user's past emotional states, allowing the analysis unit to take this into account when estimating the current emotion. By utilizing the user's past conversation history, more personalized interpretation becomes possible.

The interpretation unit can further adjust the interpretation algorithm by taking into account the user's preference information. The preference information includes words and phrases the user has preferred to use in the past, as well as the degree of interest in specific topics. For example, if the user shows a high level of interest in a particular topic, when a conversation related to that topic occurs, the interpretation unit can focus on that topic during interpretation. In addition, if the user frequently uses certain words or phrases, the interpretation unit can prioritize the interpretation of those words or phrases. By taking into account the user's preference information, more personalized interpretation becomes possible.

The confidence evaluation unit may further comprise a history reference unit that refers to the user's past confidence evaluation results. The history reference unit provides past confidence evaluation results to the confidence evaluation unit, which can use this data to perform the current confidence evaluation. For example, if an interpretation result that previously showed high confidence occurs again, the confidence evaluation unit can prioritize the evaluation of that result. Conversely, if an interpretation result that previously showed low confidence occurs again, the confidence evaluation unit can evaluate that result more carefully. By utilizing past confidence evaluation results, the accuracy of confidence evaluation is improved.

The presentation unit may further comprise a gaze tracking unit that tracks the user's gaze. The gaze tracking unit detects the user's gaze movement in real time and provides this information to the presentation unit. For example, if the user is focusing their gaze on a specific part, the presentation unit can highlight that part. In addition, if the user moves their gaze, the presentation unit can dynamically adjust the display content according to the gaze movement. By tracking the user's gaze, more intuitive and easily understandable presentation is possible.

The voice guidance unit may further comprise a voice command reception unit that receives the user's voice commands. The voice command reception unit analyzes the user's voice commands in real time and provides them to the voice guidance unit. For example, if the user issues a voice command such as “Tell me the next information,” the voice guidance unit can guide the next interpretation result. If the user issues a voice command such as “Tell me more details,” the voice guidance unit can provide detailed guidance on the interpretation result. By accepting the user's voice commands, more interactive voice guidance is possible.

The confidence evaluation unit may further comprise a feedback collection unit that collects user feedback. The feedback collection unit collects feedback provided by the user in real time and provides it to the confidence evaluation unit. For example, if the user evaluates the interpretation result as “accurate,” the confidence evaluation unit can adjust the confidence based on that evaluation. Conversely, if the user evaluates the interpretation result as “inaccurate,” the confidence evaluation unit can re-evaluate the confidence based on that evaluation. By collecting user feedback, the accuracy of confidence evaluation is improved.

Below, the flow of processing in Example 1 of the Embodiment will be briefly described.

Step 1: The voice collection unit collects the voice of the conversation partner during a conversation. For example, the voice collection unit collects the partner's voice using a microphone and sends the voice data to the analysis unit. The voice collection unit can also use noise-canceling technology to remove ambient noise and collect clear voice data. For example, the voice collection unit analyzes ambient environmental sounds in real time and removes unnecessary sounds. The voice collection unit can also filter specific frequency bands to collect only conversation voice clearly. Furthermore, the voice collection unit can use multiple microphones to identify the direction of the sound source and collect only the target voice.

Step 2: The facial expression collection unit captures the facial expressions of the partner with a camera. For example, the facial expression collection unit uses a high-resolution camera to capture subtle facial movements and collect detailed facial expression data. The facial expression collection unit can individually analyze the movements of each part of the face (eyes, mouth, eyebrows, etc.) and estimate emotions and intentions. For example, the facial expression collection unit analyzes eye movements and blinking frequency to estimate emotions and intentions. The facial expression collection unit can also analyze mouth movements and the degree of smiling to estimate emotions and intentions.

Step 3: The analysis unit extracts the meaning and context of words from the voice data and reads emotions and intentions from the facial expression data. For example, the analysis unit uses natural language processing technology to analyze the voice data and extract the meaning and context of words. The analysis unit can also use facial expression recognition technology to analyze the facial expression data and read emotions and intentions. For example, the analysis unit calculates an emotion score based on changes in facial expression and estimates intentions.

Step 4: The interpretation unit generates several interpretation candidates based on the data analyzed by the analysis unit. For example, the interpretation unit generates multiple interpretation candidates based on the analysis results and evaluates the confidence of each.

Step 5: The confidence evaluation unit evaluates the confidence of the interpretation candidates. For example, the confidence evaluation unit calculates a confidence score for the interpretation candidates and evaluates the confidence using an evaluation algorithm.

Step 6: The presentation unit presents the interpretation results to the smartphone together with the confidence. For example, the presentation unit displays the interpretation results together with the confidence score on the smartphone screen.

Step 7: The voice guidance unit explains the interpretation results via audio through earphones. For example, the voice guidance unit uses speech synthesis technology to explain the interpretation results via audio and guide the user.

### Example 2 of the Embodiment

The system according to the embodiment of the present invention is a system in which AI interprets the meaning and context of words from the voices heard and the facial expressions read from people, using earphones and glasses worn as wearable devices. In this system, the earphones first collect voice data, and the glasses collect facial expression data. Next, the AI analyzes these data and interprets the meaning and context of the words. The interpretation results are presented to the smartphone as several candidates together with their confidence, or explained via audio through the earphones. The AI can also determine how accurate what the person is saying is (i.e., whether they are lying). This system can also be used while traveling. For example, the earphones collect the voice of the conversation partner during a conversation and send the voice data to the AI. Next, the glasses capture the facial expression of the partner with a camera and send the data to the AI. Then, the AI analyzes the collected voice data and facial expression data. The AI extracts the meaning and context of words from the voice data and reads emotions and intentions from the facial expression data. For example, if the partner is speaking with a smile, the AI may determine that the words are likely a joke. The analysis results are presented to the smartphone as several interpretation candidates together with their confidence. For example, it may be displayed as “There is an 80% chance that these words are a joke.” The interpretation results may also be explained via audio through the earphones. For example, the voice guidance may say, “The partner is making a joke.” Furthermore, the AI can also determine how accurate what the person is saying is (i.e., whether they are lying). For example, the AI analyzes the tone of the partner's voice and changes in facial expression to determine whether there is a possibility of lying. This function can also be used while traveling, enabling smooth communication across language barriers. As a result, the user can accurately understand the meaning and context of the partner's words, improving the quality of communication. In addition, the function to detect lies enables the user to obtain highly reliable information. For example, when communicating with local people while traveling, using this system enables smooth communication across language barriers. Thus, the system allows the user to accurately understand the meaning and context of the partner's words and improve the quality of communication. In addition, the function to detect lies enables the user to obtain highly reliable information.

The interpretation system according to the embodiment comprises a voice collection unit, a facial expression collection unit, an analysis unit, an interpretation unit, a confidence evaluation unit, a presentation unit, and a voice guidance unit. The voice collection unit collects the voice of the conversation partner during a conversation. For example, the voice collection unit collects the partner's voice using a microphone and sends the voice data to the analysis unit. The voice collection unit can also use noise-canceling technology to remove ambient noise and collect clear voice data. For example, the voice collection unit analyzes ambient environmental sounds in real time and removes unnecessary sounds. The voice collection unit can also filter specific frequency bands to collect only conversation voice clearly. Furthermore, the voice collection unit can use multiple microphones to identify the direction of the sound source and collect only the target voice. The facial expression collection unit captures the facial expressions of the partner with a camera. For example, the facial expression collection unit uses a high-resolution camera to capture subtle facial movements and collect detailed facial expression data. The facial expression collection unit can individually analyze the movements of each part of the face (eyes, mouth, eyebrows, etc.) and estimate emotions and intentions. For example, the facial expression collection unit analyzes eye movements and blinking frequency to estimate emotions and intentions. The facial expression collection unit can also analyze mouth movements and the degree of smiling to estimate emotions and intentions. The analysis unit extracts the meaning and context of words from the voice data and reads emotions and intentions from the facial expression data. For example, the analysis unit uses natural language processing technology to analyze the voice data and extract the meaning and context of words. The analysis unit can also use facial expression recognition technology to analyze the facial expression data and read emotions and intentions. For example, the analysis unit calculates an emotion score based on changes in facial expression and estimates intentions. The interpretation unit generates several interpretation candidates based on the data analyzed by the analysis unit. For example, the interpretation unit generates multiple interpretation candidates based on the analysis results and evaluates the confidence of each. The confidence evaluation unit evaluates the confidence of the interpretation candidates. For example, the confidence evaluation unit calculates a confidence score for the interpretation candidates and evaluates the confidence using an evaluation algorithm. The presentation unit presents the interpretation results to the smartphone together with the confidence. For example, the presentation unit displays the interpretation results together with the confidence score on the smartphone screen. The voice guidance unit explains the interpretation results via audio through earphones. For example, the voice guidance unit uses speech synthesis technology to explain the interpretation results via audio and guide the user. Thus, the interpretation system according to the embodiment enables the user to accurately understand the meaning and context of the partner's words and improve the quality of communication.

The voice collection unit can collect the voice of the conversation partner during a conversation. For example, the voice collection unit collects the partner's voice using a microphone and sends the voice data to the analysis unit. The voice collection unit can also use noise-canceling technology to remove ambient noise and collect clear voice data. For example, the voice collection unit analyzes ambient environmental sounds in real time and removes unnecessary sounds. The voice collection unit can also filter specific frequency bands to collect only conversation voice clearly. Furthermore, the voice collection unit can use multiple microphones to identify the direction of the sound source and collect only the target voice. By collecting the voice of the conversation partner during a conversation, it is possible to obtain voice data in real time. Some or all of the above-described processing in the voice collection unit may be performed using AI, or may be performed without using AI. For example, the voice collection unit can input the voice data obtained by the microphone to a generative AI and have the generative AI perform the analysis of the voice data.

The facial expression collection unit can capture the facial expressions of the partner with a camera. For example, the facial expression collection unit captures the facial expressions of the partner with a high-resolution camera and sends the facial expression data to the analysis unit. The facial expression collection unit can individually analyze the movements of each part of the face (eyes, mouth, eyebrows, etc.) and estimate emotions and intentions. For example, the facial expression collection unit analyzes eye movements and blinking frequency to estimate emotions and intentions. The facial expression collection unit can also analyze mouth movements and the degree of smiling to estimate emotions and intentions. By capturing the facial expressions of the partner with a camera, it is possible to collect facial expression data. Some or all of the above-described processing in the facial expression collection unit may be performed using AI, or may be performed without using AI. For example, the facial expression collection unit can input the facial expression data obtained by the camera to a generative AI and have the generative AI perform the analysis of the facial expression data.

The analysis unit can extract the meaning and context of words from the voice data and analyze emotions and intentions from the facial expression data. For example, the analysis unit analyzes the voice data using natural language processing technology to extract the meaning and context of words. The analysis unit can also use facial expression recognition technology to analyze the facial expression data and read emotions and intentions. For example, the analysis unit calculates an emotion score based on changes in facial expression and estimates intentions. By analyzing the voice data and facial expression data, it is possible to accurately grasp the meaning and context of words, as well as emotions and intentions. Some or all of the above-described processing in the analysis unit may be performed using AI, or may be performed without using AI. For example, the analysis unit can input the voice data and facial expression data to a generative AI and have the generative AI perform the analysis of the data.

The interpretation unit can generate several interpretation candidates based on the data analyzed by the analysis unit. For example, the interpretation unit generates multiple interpretation candidates based on the analysis results and evaluates the confidence of each. The interpretation unit sends the generated interpretation candidates together with their confidence scores to the presentation unit. By generating multiple interpretation candidates, the range of interpretation is broadened, enabling more accurate interpretation. Some or all of the above-described processing in the interpretation unit may be performed using AI, or may be performed without using AI. For example, the interpretation unit can input the analysis results to a generative AI and have the generative AI generate the interpretation candidates.

The confidence evaluation unit can evaluate the confidence of the interpretation candidates. For example, the confidence evaluation unit calculates a confidence score for the interpretation candidates and evaluates the confidence using an evaluation algorithm. The confidence evaluation unit sends the evaluation results to the presentation unit and the voice guidance unit. By evaluating the confidence of the interpretation candidates, it is possible to provide the user with highly reliable interpretation results. Some or all of the above-described processing in the confidence evaluation unit may be performed using AI, or may be performed without using AI. For example, the confidence evaluation unit can input the confidence scores of the interpretation candidates to a generative AI and have the generative AI perform the confidence evaluation.

The presentation unit can present the interpretation results to the smartphone together with the confidence. For example, the presentation unit displays the interpretation results together with the confidence score on the smartphone screen. The presentation unit visually presents the interpretation results through the user interface, making it easier for the user to judge the reliability of the interpretation results. By presenting the interpretation results together with the confidence, it becomes easier for the user to judge the reliability of the interpretation results. Some or all of the above-described processing in the presentation unit may be performed using AI, or may be performed without using AI. For example, the presentation unit can input the interpretation results and confidence scores to a generative AI and have the generative AI optimize the presentation method.

The voice guidance unit can explain the interpretation results via audio through earphones. For example, the voice guidance unit uses speech synthesis technology to explain the interpretation results via audio and guide the user. The voice guidance unit explains the interpretation results together with the confidence score via audio, allowing the user to understand the interpretation results without relying on visual information. By explaining the interpretation results via audio, the user can understand the interpretation results without relying on visual information. Some or all of the above-described processing in the voice guidance unit may be performed using AI, or may be performed without using AI. For example, the voice guidance unit can input the interpretation results and confidence scores to a generative AI and have the generative AI optimize the voice guidance.

The confidence evaluation unit can analyze the tone of the partner's voice and changes in facial expression to determine whether the partner is lying. For example, the confidence evaluation unit analyzes the tone of the partner's voice to determine the possibility of lying. The confidence evaluation unit can also analyze changes in facial expression to determine the possibility of lying. For example, the confidence evaluation unit determines whether the partner is lying based on changes in the tone of the voice and changes in facial expression. By analyzing the tone of the partner's voice and changes in facial expression, it is possible to determine the possibility of lying. Some or all of the above-described processing in the confidence evaluation unit may be performed using AI, or may be performed without using AI. For example, the confidence evaluation unit can input the tone of the voice and changes in facial expression to a generative AI and have the generative AI perform lie detection.

The voice collection unit can estimate the user's emotion and adjust the timing of voice collection based on the estimated emotion. For example, if the user is nervous, the voice collection unit collects voice at the start of the conversation and waits until the user relaxes. If the user is relaxed, the voice collection unit can collect voice even during the conversation to maintain a natural conversation flow. For example, if the user is in a hurry, the voice collection unit prioritizes the collection of key points and quickly sends them to the analysis unit. By adjusting the timing of voice collection based on the user's emotion, it is possible to collect voice at more appropriate times. Emotion estimation is realized, for example, by using an emotion engine or a generative AI with emotion estimation functionality. The generative AI may be a text generation AI (e.g., LLM) or a multimodal generative AI, but is not limited to these examples. Some or all of the above-described processing in the voice collection unit may be performed using AI, or may be performed without using AI. For example, the voice collection unit can input the user's emotion data to a generative AI and have the generative AI adjust the timing of voice collection.

The voice collection unit can filter ambient environmental sounds to remove noise during voice collection. For example, the voice collection unit analyzes ambient noise in real time and removes unnecessary sounds using noise-canceling technology. The voice collection unit can also filter specific frequency bands to collect only conversation voice clearly. For example, the voice collection unit can use multiple microphones to identify the direction of the sound source and collect only the target voice. By filtering ambient environmental sounds to remove noise, it is possible to collect clear voice data. Some or all of the above-described processing in the voice collection unit may be performed using AI, or may be performed without using AI. For example, the voice collection unit can input environmental sound data to a generative AI and have the generative AI perform noise removal.

The voice collection unit can analyze the tone and speed of the partner's voice during voice collection to estimate emotions and intentions. For example, the voice collection unit analyzes the tone of the partner's voice in real time to detect changes in emotion. The voice collection unit can also analyze the speed of the partner's voice to estimate signs of nervousness or impatience. For example, the voice collection unit analyzes intonation and strength of the voice to estimate the partner's intentions and emotions. By analyzing the tone and speed of the partner's voice, it is possible to estimate emotions and intentions. Emotion estimation is realized, for example, by using an emotion engine or a generative AI with emotion estimation functionality. The generative AI may be a text generation AI (e.g., LLM) or a multimodal generative AI, but is not limited to these examples. Some or all of the above-described processing in the voice collection unit may be performed using AI, or may be performed without using AI. For example, the voice collection unit can input the partner's tone and speed data to a generative AI and have the generative AI estimate emotions and intentions.

The voice collection unit can estimate the user's emotion and determine the priority of the voice to be collected based on the estimated emotion. For example, if the user is nervous, the voice collection unit prioritizes the collection of important parts of the conversation. If the user is relaxed, the voice collection unit can collect the entire conversation in a balanced manner. For example, if the user is in a hurry, the voice collection unit prioritizes the collection of key points. By determining the priority of the voice to be collected based on the user's emotion, it is possible to prioritize the collection of important voice data. Emotion estimation is realized, for example, by using an emotion engine or a generative AI with emotion estimation functionality. The generative AI may be a text generation AI (e.g., LLM) or a multimodal generative AI, but is not limited to these examples. Some or all of the above-described processing in the voice collection unit may be performed using AI, or may be performed without using AI. For example, the voice collection unit can input the user's emotion data to a generative AI and have the generative AI determine the priority of the voice to be collected.

The voice collection unit can prioritize the collection of relevant voice data by considering the user's geographic location during voice collection. For example, when the user is in a specific location, the voice collection unit prioritizes the collection of conversations related to that location. When the user is moving, the voice collection unit can prioritize the collection of conversations containing information related to the destination. For example, when the user is at a tourist spot, the voice collection unit prioritizes the collection of conversations related to the history and culture of that place. By considering the user's geographic location, it is possible to prioritize the collection of relevant voice data. Some or all of the above-described processing in the voice collection unit may be performed using AI, or may be performed without using AI. For example, the voice collection unit can input geographic location information to a generative AI and have the generative AI perform the collection of relevant voice data.

The voice collection unit can analyze the user's social media activity during voice collection and collect relevant voice data. For example, the voice collection unit analyzes the user's social media posts and prioritizes the collection of relevant conversations. The voice collection unit can also collect relevant voice data based on information from accounts followed by the user. For example, the voice collection unit considers the user's active time on social media and collects voice data relevant to that time period. By analyzing the user's social media activity, it is possible to collect relevant voice data. Some or all of the above-described processing in the voice collection unit may be performed using AI, or may be performed without using AI. For example, the voice collection unit can input social media data to a generative AI and have the generative AI perform the collection of relevant voice data.

The facial expression collection unit can estimate the user's emotion and adjust the timing of facial expression collection based on the estimated emotion. For example, if the user is nervous, the facial expression collection unit collects facial expressions at the start of the conversation and waits until the user relaxes. If the user is relaxed, the facial expression collection unit can collect facial expressions even during the conversation to maintain a natural conversation flow. For example, if the user is in a hurry, the facial expression collection unit prioritizes the collection of key points and quickly sends them to the analysis unit. By adjusting the timing of facial expression collection based on the user's emotion, it is possible to collect facial expressions at more appropriate times. Emotion estimation is realized, for example, by using an emotion engine or a generative AI with emotion estimation functionality. The generative AI may be a text generation AI (e.g., LLM) or a multimodal generative AI, but is not limited to these examples. Some or all of the above-described processing in the facial expression collection unit may be performed using AI, or may be performed without using AI. For example, the facial expression collection unit can input the user's emotion data to a generative AI and have the generative AI adjust the timing of facial expression collection.

The facial expression collection unit can use a high-resolution camera to capture subtle facial movements during facial expression collection. For example, the facial expression collection unit uses a high-resolution camera to capture subtle facial movements and collect detailed facial expression data. The facial expression collection unit can capture subtle movements of each part of the face (eyes, mouth, eyebrows, etc.) with a high-resolution camera and send them to the analysis unit. For example, the facial expression collection unit collects subtle facial movements in real time and sends them to the analysis unit. By using a high-resolution camera, it is possible to collect subtle facial movements in detail. Some or all of the above-described processing in the facial expression collection unit may be performed using AI, or may be performed without using AI. For example, the facial expression collection unit can input facial expression data obtained by the high-resolution camera to a generative AI and have the generative AI analyze the subtle movements.

The facial expression collection unit can individually analyze the movements of each part of the face during facial expression collection. For example, the facial expression collection unit individually analyzes the movements of each part of the face (eyes, mouth, eyebrows, etc.) and collects detailed facial expression data. The facial expression collection unit can also analyze eye movements and blinking frequency to estimate emotions and intentions. For example, the facial expression collection unit analyzes mouth movements and the degree of smiling to estimate emotions and intentions. By individually analyzing the movements of each part of the face, it is possible to collect detailed facial expression data. Some or all of the above-described processing in the facial expression collection unit may be performed using AI, or may be performed without using AI. For example, the facial expression collection unit can input movement data of each part of the face to a generative AI and have the generative AI analyze the movements.

The facial expression collection unit can estimate the user's emotion and determine the priority of the facial expressions to be collected based on the estimated emotion. For example, if the user is nervous, the facial expression collection unit prioritizes the collection of important facial expressions. If the user is relaxed, the facial expression collection unit can collect the overall facial expressions in a balanced manner. For example, if the user is in a hurry, the facial expression collection unit prioritizes the collection of key facial expressions. By determining the priority of the facial expressions to be collected based on the user's emotion, it is possible to prioritize the collection of important facial expressions. Emotion estimation is realized, for example, by using an emotion engine or a generative AI with emotion estimation functionality. The generative AI may be a text generation AI (e.g., LLM) or a multimodal generative AI, but is not limited to these examples. Some or all of the above-described processing in the facial expression collection unit may be performed using AI, or may be performed without using AI. For example, the facial expression collection unit can input the user's emotion data to a generative AI and have the generative AI determine the priority of the facial expressions to be collected.

The facial expression collection unit can prioritize the collection of relevant facial expressions by considering the user's geographic location during facial expression collection. For example, when the user is in a specific location, the facial expression collection unit prioritizes the collection of facial expressions related to that location. When the user is moving, the facial expression collection unit can prioritize the collection of facial expressions containing information related to the destination. For example, when the user is at a tourist spot, the facial expression collection unit prioritizes the collection of facial expressions related to the history and culture of that place. By considering the user's geographic location, it is possible to prioritize the collection of relevant facial expressions. Some or all of the above-described processing in the facial expression collection unit may be performed using AI, or may be performed without using AI. For example, the facial expression collection unit can input geographic location information to a generative AI and have the generative AI perform the collection of relevant facial expressions.

The facial expression collection unit can analyze the user's social media activity during facial expression collection and collect relevant facial expressions. For example, the facial expression collection unit analyzes the user's social media posts and prioritizes the collection of relevant facial expressions. The facial expression collection unit can also collect relevant facial expressions based on information from accounts followed by the user. For example, the facial expression collection unit considers the user's active time on social media and collects facial expressions relevant to that time period. By analyzing the user's social media activity, it is possible to collect relevant facial expressions. Some or all of the above-described processing in the facial expression collection unit may be performed using AI, or may be performed without using AI. For example, the facial expression collection unit can input social media data to a generative AI and have the generative AI perform the collection of relevant facial expressions.

The analysis unit can estimate the user's emotion and adjust the analysis algorithm based on the estimated emotion. For example, if the user is nervous, the analysis unit applies an algorithm that emphasizes changes in emotion. If the user is relaxed, the analysis unit can apply an algorithm that emphasizes the overall context. For example, if the user is in a hurry, the analysis unit applies an algorithm that focuses on key points. By adjusting the analysis algorithm based on the user's emotion, more appropriate analysis is possible. Emotion estimation is realized, for example, by using an emotion engine or a generative AI with emotion estimation functionality. The generative AI may be a text generation AI (e.g., LLM) or a multimodal generative AI, but is not limited to these examples. Some or all of the above-described processing in the analysis unit may be performed using AI, or may be performed without using AI. For example, the analysis unit can input the user's emotion data to a generative AI and have the generative AI adjust the analysis algorithm.

The analysis unit can improve analysis accuracy by considering the interrelationship between voice data and facial expression data during analysis. For example, the analysis unit synchronizes the timing of voice data and facial expression data and analyzes their interrelationship. The analysis unit can also combine the tone of the voice data and changes in the facial expression data for analysis. For example, the analysis unit integrates the content of the voice data and the emotion of the facial expression data for analysis. By considering the interrelationship between voice data and facial expression data, analysis accuracy is improved. Some or all of the above-described processing in the analysis unit may be performed using AI, or may be performed without using AI. For example, the analysis unit can input voice data and facial expression data to a generative AI and have the generative AI analyze the interrelationship.

The analysis unit can optimize the analysis algorithm by referring to past data during analysis. For example, the analysis unit refers to past conversation data to optimize the analysis algorithm. The analysis unit can also refer to past facial expression data to optimize the analysis algorithm. For example, the analysis unit refers to past correlation data between voice and facial expressions to optimize the analysis algorithm. By referring to past data, the analysis algorithm can be optimized. Some or all of the above-described processing in the analysis unit may be performed using AI, or may be performed without using AI. For example, the analysis unit can input past data to a generative AI and have the generative AI optimize the analysis algorithm.

The analysis unit can estimate the user's emotion and adjust the display method of analysis results based on the estimated emotion. For example, if the user is nervous, the analysis unit provides a simple and highly visible display method. If the user is relaxed, the analysis unit can provide a display method that includes detailed information. For example, if the user is in a hurry, the analysis unit provides a display method that focuses on key points. By adjusting the display method of analysis results based on the user's emotion, it is possible to provide a display that is easy for the user to understand. Emotion estimation is realized, for example, by using an emotion engine or a generative AI with emotion estimation functionality. The generative AI may be a text generation AI (e.g., LLM) or a multimodal generative AI, but is not limited to these examples. Some or all of the above-described processing in the analysis unit may be performed using AI, or may be performed without using AI. For example, the analysis unit can input the user's emotion data to a generative AI and have the generative AI adjust the display method.

The analysis unit can perform analysis by considering the geographic distribution of voice data and facial expression data during analysis. For example, the analysis unit considers the collection locations of voice data and facial expression data and analyzes the geographic distribution. The analysis unit can also analyze patterns of voice and facial expressions in specific regions. For example, the analysis unit adjusts the analysis algorithm based on the geographic distribution. By considering the geographic distribution of voice data and facial expression data, more accurate analysis is possible. Some or all of the above-described processing in the analysis unit may be performed using AI, or may be performed without using AI. For example, the analysis unit can input geographic distribution data to a generative AI and have the generative AI perform the analysis.

The analysis unit can improve analysis accuracy by referring to related literature during analysis. For example, the analysis unit refers to the latest research papers to improve the analysis algorithm. The analysis unit can also refer to related patent literature to optimize the analysis method. For example, the analysis unit refers to past research data to improve analysis accuracy. By referring to related literature, analysis accuracy is improved. Some or all of the above-described processing in the analysis unit may be performed using AI, or may be performed without using AI. For example, the analysis unit can input related literature data to a generative AI and have the generative AI improve analysis accuracy.

The interpretation unit can estimate the user's emotion and adjust the interpretation algorithm based on the estimated emotion. For example, if the user is nervous, the interpretation unit applies an algorithm that emphasizes changes in emotion. If the user is relaxed, the interpretation unit can apply an algorithm that emphasizes the overall context. For example, if the user is in a hurry, the interpretation unit applies an algorithm that focuses on key points. By adjusting the interpretation algorithm based on the user's emotion, more appropriate interpretation is possible. Emotion estimation is realized, for example, by using an emotion engine or a generative AI with emotion estimation functionality. The generative AI may be a text generation AI (e.g., LLM) or a multimodal generative AI, but is not limited to these examples. Some or all of the above-described processing in the interpretation unit may be performed using AI, or may be performed without using AI. For example, the interpretation unit can input the user's emotion data to a generative AI and have the generative AI adjust the interpretation algorithm.

The interpretation unit can improve interpretation accuracy by considering the interrelationship between voice data and facial expression data during interpretation. For example, the interpretation unit synchronizes the timing of voice data and facial expression data and interprets their interrelationship. The interpretation unit can also combine the tone of the voice data and changes in the facial expression data for interpretation. For example, the interpretation unit integrates the content of the voice data and the emotion of the facial expression data for interpretation. By considering the interrelationship between voice data and facial expression data, interpretation accuracy is improved. Some or all of the above-described processing in the interpretation unit may be performed using AI, or may be performed without using AI. For example, the interpretation unit can input voice data and facial expression data to a generative AI and have the generative AI interpret the interrelationship.

The interpretation unit can optimize the interpretation algorithm by referring to past data during interpretation. For example, the interpretation unit refers to past conversation data to optimize the interpretation algorithm. The interpretation unit can also refer to past facial expression data to optimize the interpretation algorithm. For example, the interpretation unit refers to past correlation data between voice and facial expressions to optimize the interpretation algorithm. By referring to past data, the interpretation algorithm can be optimized. Some or all of the above-described processing in the interpretation unit may be performed using AI, or may be performed without using AI. For example, the interpretation unit can input past data to a generative AI and have the generative AI optimize the interpretation algorithm.

The interpretation unit can estimate the user's emotion and adjust the display method of interpretation results based on the estimated emotion. For example, if the user is nervous, the interpretation unit provides a simple and highly visible display method. If the user is relaxed, the interpretation unit can provide a display method that includes detailed information. For example, if the user is in a hurry, the interpretation unit provides a display method that focuses on key points. By adjusting the display method of interpretation results based on the user's emotion, it is possible to provide a display that is easy for the user to understand. Emotion estimation is realized, for example, by using an emotion engine or a generative AI with emotion estimation functionality. The generative AI may be a text generation AI (e.g., LLM) or a multimodal generative AI, but is not limited to these examples. Some or all of the above-described processing in the interpretation unit may be performed using AI, or may be performed without using AI. For example, the interpretation unit can input the user's emotion data to a generative AI and have the generative AI adjust the display method.

The interpretation unit can perform interpretation by considering the geographic distribution of voice data and facial expression data during interpretation. For example, the interpretation unit considers the collection locations of voice data and facial expression data and interprets the geographic distribution. The interpretation unit can also interpret patterns of voice and facial expressions in specific regions. For example, the interpretation unit adjusts the interpretation algorithm based on the geographic distribution. By considering the geographic distribution of voice data and facial expression data, more accurate interpretation is possible. Some or all of the above-described processing in the interpretation unit may be performed using AI, or may be performed without using AI. For example, the interpretation unit can input geographic distribution data to a generative AI and have the generative AI perform the interpretation.

The interpretation unit can improve interpretation accuracy by referring to related literature during interpretation. For example, the interpretation unit refers to the latest research papers to improve the interpretation algorithm. The interpretation unit can also refer to related patent literature to optimize the interpretation method. For example, the interpretation unit refers to past research data to improve interpretation accuracy. By referring to related literature, interpretation accuracy is improved. Some or all of the above-described processing in the interpretation unit may be performed using AI, or may be performed without using AI. For example, the interpretation unit can input related literature data to a generative AI and have the generative AI improve interpretation accuracy.

The confidence evaluation unit can estimate the user's emotion and adjust the confidence evaluation algorithm based on the estimated emotion. For example, if the user is nervous, the confidence evaluation unit applies an algorithm that emphasizes changes in emotion. If the user is relaxed, the confidence evaluation unit can apply an algorithm that emphasizes the overall context. For example, if the user is in a hurry, the confidence evaluation unit applies an algorithm that focuses on key points. By adjusting the confidence evaluation algorithm based on the user's emotion, more appropriate confidence evaluation is possible. Emotion estimation is realized, for example, by using an emotion engine or a generative AI with emotion estimation functionality. The generative AI may be a text generation AI (e.g., LLM) or a multimodal generative AI, but is not limited to these examples. Some or all of the above-described processing in the confidence evaluation unit may be performed using AI, or may be performed without using AI. For example, the confidence evaluation unit can input the user's emotion data to a generative AI and have the generative AI adjust the confidence evaluation algorithm.

The confidence evaluation unit can improve the accuracy of confidence by considering the interrelationship between voice data and facial expression data during confidence evaluation. For example, the confidence evaluation unit synchronizes the timing of voice data and facial expression data and evaluates their interrelationship. The confidence evaluation unit can also combine the tone of the voice data and changes in the facial expression data for evaluation. For example, the confidence evaluation unit integrates the content of the voice data and the emotion of the facial expression data for evaluation. By considering the interrelationship between voice data and facial expression data, the accuracy of confidence is improved. Some or all of the above-described processing in the confidence evaluation unit may be performed using AI, or may be performed without using AI. For example, the confidence evaluation unit can input voice data and facial expression data to a generative AI and have the generative AI evaluate the interrelationship.

The confidence evaluation unit can optimize the confidence evaluation algorithm by referring to past data during confidence evaluation. For example, the confidence evaluation unit refers to past conversation data to optimize the confidence evaluation algorithm. The confidence evaluation unit can also refer to past facial expression data to optimize the confidence evaluation algorithm. For example, the confidence evaluation unit refers to past correlation data between voice and facial expressions to optimize the confidence evaluation algorithm. By referring to past data, the confidence evaluation algorithm can be optimized. Some or all of the above-described processing in the confidence evaluation unit may be performed using AI, or may be performed without using AI. For example, the confidence evaluation unit can input past data to a generative AI and have the generative AI optimize the confidence evaluation algorithm.

The confidence evaluation unit can estimate the user's emotion and adjust the display method of confidence evaluation results based on the estimated emotion. For example, if the user is nervous, the confidence evaluation unit provides a simple and highly visible display method. If the user is relaxed, the confidence evaluation unit can provide a display method that includes detailed information. For example, if the user is in a hurry, the confidence evaluation unit provides a display method that focuses on key points. By adjusting the display method of confidence evaluation results based on the user's emotion, it is possible to provide a display that is easy for the user to understand. Emotion estimation is realized, for example, by using an emotion engine or a generative AI with emotion estimation functionality. The generative AI may be a text generation AI (e.g., LLM) or a multimodal generative AI, but is not limited to these examples. Some or all of the above-described processing in the confidence evaluation unit may be performed using AI, or may be performed without using AI. For example, the confidence evaluation unit can input the user's emotion data to a generative AI and have the generative AI adjust the display method.

The confidence evaluation unit can perform confidence evaluation by considering the geographic distribution of voice data and facial expression data during confidence evaluation. For example, the confidence evaluation unit considers the collection locations of voice data and facial expression data and evaluates the geographic distribution. The confidence evaluation unit can also evaluate patterns of voice and facial expressions in specific regions. For example, the confidence evaluation unit adjusts the confidence evaluation algorithm based on the geographic distribution. By considering the geographic distribution of voice data and facial expression data, more accurate confidence evaluation is possible. Some or all of the above-described processing in the confidence evaluation unit may be performed using AI, or may be performed without using AI. For example, the confidence evaluation unit can input geographic distribution data to a generative AI and have the generative AI perform the confidence evaluation.

The confidence evaluation unit can improve the accuracy of confidence evaluation by referring to related literature during confidence evaluation. For example, the confidence evaluation unit refers to the latest research papers to improve the confidence evaluation algorithm. The confidence evaluation unit can also refer to related patent literature to optimize the confidence evaluation method. For example, the confidence evaluation unit refers to past research data to improve the accuracy of confidence evaluation. By referring to related literature, the accuracy of confidence evaluation is improved. Some or all of the above-described processing in the confidence evaluation unit may be performed using AI, or may be performed without using AI. For example, the confidence evaluation unit can input related literature data to a generative AI and have the generative AI improve the accuracy of confidence evaluation.

The presentation unit can estimate the user's emotion and adjust the presentation method based on the estimated emotion. For example, if the user is nervous, the presentation unit provides a simple and highly visible display method. If the user is relaxed, the presentation unit can provide a display method that includes detailed information. For example, if the user is in a hurry, the presentation unit provides a display method that focuses on key points. By adjusting the presentation method based on the user's emotion, it is possible to provide a display that is easy for the user to understand. Emotion estimation is realized, for example, by using an emotion engine or a generative AI with emotion estimation functionality. The generative AI may be a text generation AI (e.g., LLM) or a multimodal generative AI, but is not limited to these examples. Some or all of the above-described processing in the presentation unit may be performed using AI, or may be performed without using AI. For example, the presentation unit can input the user's emotion data to a generative AI and have the generative AI adjust the presentation method.

The presentation unit can adjust the level of detail of the presentation based on the importance of the interpretation results during presentation. For example, the presentation unit displays important interpretation results in detail to make them easier for the user to understand. The presentation unit can also display less important interpretation results concisely to reduce the user's burden. For example, the presentation unit dynamically adjusts the display content according to the importance of the interpretation results. By adjusting the level of detail of the presentation based on the importance of the interpretation results, important information can be prioritized for the user. Some or all of the above-described processing in the presentation unit may be performed using AI, or may be performed without using AI. For example, the presentation unit can input importance data of the interpretation results to a generative AI and have the generative AI adjust the level of detail of the presentation.

The presentation unit can apply different presentation algorithms according to the category of the interpretation results during presentation. For example, the presentation unit visually displays interpretation results related to emotions to allow the user to intuitively understand them. The presentation unit can also display interpretation results related to context as text to provide detailed information. For example, the presentation unit displays interpretation results related to confidence as graphs to show reliability to the user. By applying different presentation algorithms according to the category of the interpretation results, optimal display for the user is possible. Some or all of the above-described processing in the presentation unit may be performed using AI, or may be performed without using AI. For example, the presentation unit can input category data of the interpretation results to a generative AI and have the generative AI apply the presentation algorithm.

The presentation unit can estimate the user's emotion and adjust the length of the presentation based on the estimated emotion. For example, if the user is nervous, the presentation unit provides a short and concise display method. If the user is relaxed, the presentation unit can provide a longer display method including detailed explanations. For example, if the user is in a hurry, the presentation unit provides a short display method that can be quickly understood. By adjusting the length of the presentation based on the user's emotion, it is possible to provide a display that is easy for the user to understand. Emotion estimation is realized, for example, by using an emotion engine or a generative AI with emotion estimation functionality. The generative AI may be a text generation AI (e.g., LLM) or a multimodal generative AI, but is not limited to these examples. Some or all of the above-described processing in the presentation unit may be performed using AI, or may be performed without using AI. For example, the presentation unit can input the user's emotion data to a generative AI and have the generative AI adjust the length of the presentation.

The presentation unit can determine the priority of the presentation based on the submission timing of the interpretation results during presentation. For example, the presentation unit prioritizes the display of the latest interpretation results to provide information to the user quickly. The presentation unit can also display past interpretation results concisely to reduce the user's burden. For example, the presentation unit dynamically adjusts the display content according to the submission timing of the interpretation results. By determining the priority of the presentation based on the submission timing of the interpretation results, the latest information can be provided quickly. Some or all of the above-described processing in the presentation unit may be performed using AI, or may be performed without using AI. For example, the presentation unit can input submission timing data of the interpretation results to a generative AI and have the generative AI determine the priority of the presentation.

The presentation unit can adjust the order of the presentation based on the relevance of the interpretation results during presentation. For example, the presentation unit prioritizes the display of highly relevant interpretation results to provide important information to the user. The presentation unit can also display less relevant interpretation results concisely to reduce the user's burden. For example, the presentation unit dynamically adjusts the display content according to the relevance of the interpretation results. By adjusting the order of the presentation based on the relevance of the interpretation results, important information can be prioritized for the user. Some or all of the above-described processing in the presentation unit may be performed using AI, or may be performed without using AI. For example, the presentation unit can input relevance data of the interpretation results to a generative AI and have the generative AI adjust the order of the presentation.

The voice guidance unit can estimate the user's emotion and adjust the expression method of the voice guidance based on the estimated emotion. For example, if the user is nervous, the voice guidance unit provides guidance in a calm voice. If the user is relaxed, the voice guidance unit can provide guidance in a cheerful voice. For example, if the user is in a hurry, the voice guidance unit provides quick and concise voice guidance. By adjusting the expression method of the voice guidance based on the user's emotion, it is possible to provide guidance that is easy for the user to understand. Emotion estimation is realized, for example, by using an emotion engine or a generative AI with emotion estimation functionality. The generative AI may be a text generation AI (e.g., LLM) or a multimodal generative AI, but is not limited to these examples. Some or all of the above-described processing in the voice guidance unit may be performed using AI, or may be performed without using AI. For example, the voice guidance unit can input the user's emotion data to a generative AI and have the generative AI adjust the expression method of the voice guidance.

The voice guidance unit can adjust the level of detail of the guidance based on the importance of the interpretation results during voice guidance. For example, the voice guidance unit explains important interpretation results in detail to make them easier for the user to understand. The voice guidance unit can also explain less important interpretation results concisely to reduce the user's burden. For example, the voice guidance unit dynamically adjusts the guidance content according to the importance of the interpretation results. By adjusting the level of detail of the guidance based on the importance of the interpretation results, important information can be prioritized for the user. Some or all of the above-described processing in the voice guidance unit may be performed using AI, or may be performed without using AI. For example, the voice guidance unit can input importance data of the interpretation results to a generative AI and have the generative AI adjust the level of detail of the guidance.

The voice guidance unit can apply different guidance algorithms according to the category of the interpretation results during voice guidance. For example, the voice guidance unit visually explains interpretation results related to emotions to allow the user to intuitively understand them. The voice guidance unit can also explain interpretation results related to context as text to provide detailed information. For example, the voice guidance unit explains interpretation results related to confidence as graphs to show reliability to the user. By applying different guidance algorithms according to the category of the interpretation results, optimal guidance for the user is possible. Some or all of the above-described processing in the voice guidance unit may be performed using AI, or may be performed without using AI. For example, the voice guidance unit can input category data of the interpretation results to a generative AI and have the generative AI apply the guidance algorithm.

The voice guidance unit can estimate the user's emotion and adjust the length of the voice guidance based on the estimated emotion. For example, when the user is nervous, the voice guidance unit provides short guidance focusing on key points. When the user is relaxed, the voice guidance unit can provide longer guidance including detailed explanations. For example, when the user is in a hurry, the voice guidance unit provides brief guidance that can be quickly understood. In this manner, by adjusting the length of the voice guidance according to the user's emotion, guidance that is easy for the user to understand can be provided. Emotion estimation may be realized using, for example, an emotion engine or a generative AI with an emotion estimation function. The generative AI may be a text generation AI (such as an LLM) or a multimodal generative AI, but is not limited thereto. Some or all of the above-described processing in the voice guidance unit may be performed using AI, or may be performed without using AI. For example, the voice guidance unit may input the user's emotion data to a generative AI and have the generative AI perform the adjustment of the guidance length.

The voice guidance unit can determine the priority of the guidance based on the submission timing of the interpretation results during voice guidance. For example, the voice guidance unit prioritizes the guidance of the latest interpretation results to provide information to the user quickly. The voice guidance unit can also provide concise guidance for past interpretation results to reduce the user's burden. For example, the voice guidance unit dynamically adjusts the guidance content according to the submission timing of the interpretation results. By determining the priority of the guidance based on the submission timing of the interpretation results, the latest information can be provided quickly. Some or all of the above-described processing in the voice guidance unit may be performed using AI, or may be performed without using AI. For example, the voice guidance unit can input submission timing data of the interpretation results to a generative AI and have the generative AI determine the priority of the guidance.

The voice guidance unit can adjust the order of the guidance based on the relevance of the interpretation results during voice guidance. For example, the voice guidance unit prioritizes the guidance of highly relevant interpretation results to provide important information to the user. The voice guidance unit can also provide concise guidance for less relevant interpretation results to reduce the user's burden. For example, the voice guidance unit dynamically adjusts the guidance content according to the relevance of the interpretation results. By adjusting the order of the guidance based on the relevance of the interpretation results, important information can be prioritized for the user. Some or all of the above-described processing in the voice guidance unit may be performed using AI, or may be performed without using AI. For example, the voice guidance unit can input relevance data of the interpretation results to a generative AI and have the generative AI adjust the order of the guidance.

The system according to the embodiment is not limited to the above-described examples and can be variously modified as follows, for example.

The interpretation system may further comprise a history reference unit that refers to the user's past conversation history. The history reference unit provides past conversation data to the analysis unit, which can use this data to more accurately interpret the context of the current conversation. For example, if the user has previously discussed a specific topic, when a new conversation related to that topic occurs, the system can refer to past information to improve interpretation accuracy. In addition, the history reference unit can also record the user's past emotional states, allowing the analysis unit to take this into account when estimating the current emotion. By utilizing the user's past conversation history, more personalized interpretation becomes possible.

The voice collection unit may further analyze, in real time, the tone and speed of the user's voice to estimate the user's emotions and intentions. For example, when the user is excited, the voice tone tends to become higher and the speed tends to increase. The voice collection unit detects these changes and transmits them to the analysis unit, thereby enabling the analysis unit to more accurately grasp the user's emotions and intentions. In addition, the voice collection unit can also emphasize important parts of the conversation based on changes in the user's voice tone and speed. In this way, by analyzing the tone and speed of the user's voice, emotions and intentions can be more accurately estimated.

The facial expression collection unit may further include a temperature sensor that detects changes in the user's facial temperature. The temperature sensor detects changes in the user's facial temperature in real time and transmits this information to the analysis unit. For example, when the user is nervous, the facial temperature may rise. The analysis unit can estimate the user's emotion based on this temperature change and reflect it in the interpretation results. Additionally, when the user is relaxed, the temperature sensor can detect that the facial temperature is stable and provide this information to the analysis unit. In this way, detecting changes in facial temperature enables more accurate emotion estimation.

The analysis unit may further include a biometric information analysis unit that analyzes the user's biometric information. The biometric information analysis unit collects biometric information such as the user's heart rate and skin conductance and provides it to the analysis unit. For example, when the user is nervous, the heart rate may increase and skin conductance may rise. The analysis unit can estimate the user's emotion based on such biometric information and reflect it in the interpretation results. Additionally, when the user is relaxed, the biometric information analysis unit can detect that the heart rate is stable and skin conductance is reduced, and provide this information to the analysis unit. In this way, analyzing biometric information enables more accurate emotion estimation.

The interpretation unit can further adjust the interpretation algorithm by taking into account the user's preference information. The preference information includes words and phrases the user has preferred to use in the past, as well as the degree of interest in specific topics. For example, if the user shows a high level of interest in a particular topic, when a conversation related to that topic occurs, the interpretation unit can focus on that topic during interpretation. In addition, if the user frequently uses certain words or phrases, the interpretation unit can prioritize the interpretation of those words or phrases. By taking into account the user's preference information, more personalized interpretation becomes possible.

The confidence evaluation unit may further comprise a history reference unit that refers to the user's past confidence evaluation results. The history reference unit provides past confidence evaluation results to the confidence evaluation unit, which can use this data to perform the current confidence evaluation. For example, if an interpretation result that previously showed high confidence occurs again, the confidence evaluation unit can prioritize the evaluation of that result. Conversely, if an interpretation result that previously showed low confidence occurs again, the confidence evaluation unit can evaluate that result more carefully. By utilizing past confidence evaluation results, the accuracy of confidence evaluation is improved.

The presentation unit may further comprise a gaze tracking unit that tracks the user's gaze. The gaze tracking unit detects the user's gaze movement in real time and provides this information to the presentation unit. For example, if the user is focusing their gaze on a specific part, the presentation unit can highlight that part. In addition, if the user moves their gaze, the presentation unit can dynamically adjust the display content according to the gaze movement. By tracking the user's gaze, more intuitive and easily understandable presentation is possible.

The voice guidance unit may further comprise a voice command reception unit that receives the user's voice commands. The voice command reception unit analyzes the user's voice commands in real time and provides them to the voice guidance unit. For example, if the user issues a voice command such as “Tell me the next information,” the voice guidance unit can guide the next interpretation result. If the user issues a voice command such as “Tell me more details,” the voice guidance unit can provide detailed guidance on the interpretation result. By accepting the user's voice commands, more interactive voice guidance is possible.

The confidence evaluation unit may further comprise a feedback collection unit that collects user feedback. The feedback collection unit collects feedback provided by the user in real time and provides it to the confidence evaluation unit. For example, if the user evaluates the interpretation result as “accurate,” the confidence evaluation unit can adjust the confidence based on that evaluation. Conversely, if the user evaluates the interpretation result as “inaccurate,” the confidence evaluation unit can re-evaluate the confidence based on that evaluation. By collecting user feedback, the accuracy of confidence evaluation is improved.

The analysis unit may further include a biometric information analysis unit that analyzes the user's real-time biometric information. The biometric information analysis unit collects biometric information such as the user's heart rate and skin conductance in real time and provides it to the analysis unit. For example, when the user is nervous, the heart rate may increase and skin conductance may rise. The analysis unit can estimate the user's emotion based on such biometric information and reflect it in the interpretation results. Additionally, when the user is relaxed, the biometric information analysis unit can detect that the heart rate is stable and skin conductance is reduced, and provide this information to the analysis unit. In this way, analyzing biometric information enables more accurate emotion estimation.

The following is a brief description of the processing flow in Embodiment 2.

Step 1: The voice collection unit collects the voice of the conversation partner during a conversation. For example, the voice collection unit collects the partner's voice using a microphone and sends the voice data to the analysis unit. The voice collection unit can also use noise-canceling technology to remove ambient noise and collect clear voice data. For example, the voice collection unit analyzes ambient environmental sounds in real time and removes unnecessary sounds. The voice collection unit can also filter specific frequency bands to collect only conversation voice clearly. Furthermore, the voice collection unit can use multiple microphones to identify the direction of the sound source and collect only the target voice.

Step 2: The facial expression collection unit captures the facial expressions of the partner with a camera. For example, the facial expression collection unit uses a high-resolution camera to capture subtle facial movements and collect detailed facial expression data. The facial expression collection unit can individually analyze the movements of each part of the face (eyes, mouth, eyebrows, etc.) and estimate emotions and intentions. For example, the facial expression collection unit analyzes eye movements and blinking frequency to estimate emotions and intentions. The facial expression collection unit can also analyze mouth movements and the degree of smiling to estimate emotions and intentions.

Step 3: The analysis unit extracts the meaning and context of words from the voice data and reads emotions and intentions from the facial expression data. For example, the analysis unit uses natural language processing technology to analyze the voice data and extract the meaning and context of words. The analysis unit can also use facial expression recognition technology to analyze the facial expression data and read emotions and intentions. For example, the analysis unit calculates an emotion score based on changes in facial expression and estimates intentions.

Step 4: The interpretation unit generates several interpretation candidates based on the data analyzed by the analysis unit. For example, the interpretation unit generates multiple interpretation candidates based on the analysis results and evaluates the confidence of each.

Step 5: The confidence evaluation unit evaluates the confidence of the interpretation candidates. For example, the confidence evaluation unit calculates a confidence score for the interpretation candidates and evaluates the confidence using an evaluation algorithm.

Step 6: The presentation unit presents the interpretation results to the smartphone together with the confidence. For example, the presentation unit displays the interpretation results together with the confidence score on the smartphone screen.

Step 7: The voice guidance unit explains the interpretation results via audio through earphones. For example, the voice guidance unit uses speech synthesis technology to explain the interpretation results via audio and guide the user.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the above-described elements, including the voice collection unit, facial expression collection unit, analysis unit, interpretation unit, confidence evaluation unit, presentation unit, and voice guidance unit, is implemented by at least one of, for example, the smart device 14 and the data processing apparatus 12. For example, the voice collection unit collects the partner's voice using the microphone 38B of the smart device 14 and transmits it to the specific processing unit 290 of the data processing apparatus 12. The facial expression collection unit captures the partner's facial expression using the camera 42 of the smart device 14 and transmits it to the specific processing unit 290 of the data processing apparatus 12. The analysis unit is implemented by the specific processing unit 290 of the data processing apparatus 12 and analyzes the voice data and facial expression data. The interpretation unit is implemented by the specific processing unit 290 of the data processing apparatus 12 and generates interpretation candidates based on the analysis results. The confidence evaluation unit is implemented by the specific processing unit 290 of the data processing apparatus 12 and evaluates the confidence of the interpretation candidates. The presentation unit displays the interpretation results using the display 40A of the smart device 14. The voice guidance unit explains the interpretation results via audio using the speaker 40B of the smart device 14. The correspondence between each unit and the device or control unit is not limited to the above examples and various modifications are possible.

### Second Embodiment

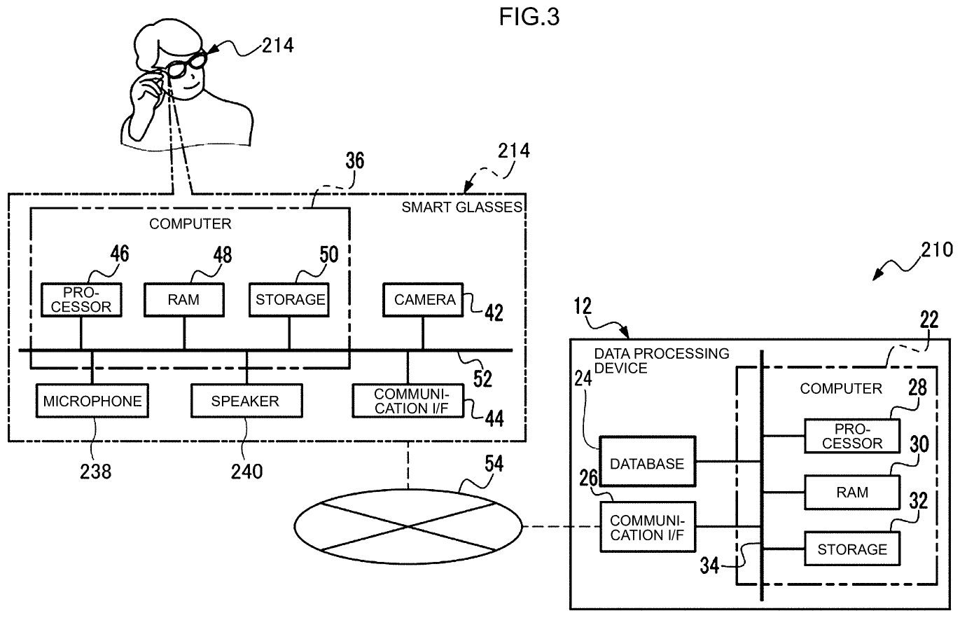

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

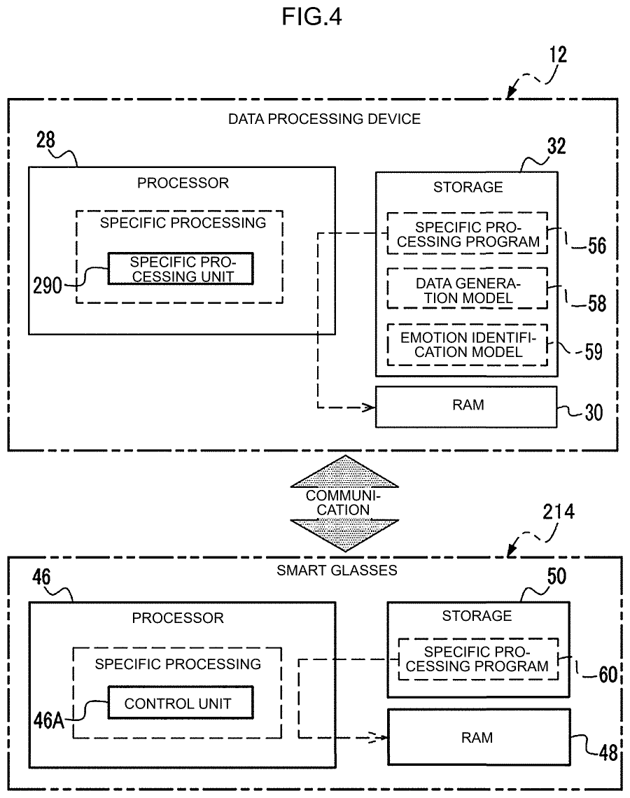

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the above-described elements, including the voice collection unit, facial expression collection unit, analysis unit, interpretation unit, confidence evaluation unit, presentation unit, and voice guidance unit, is implemented by at least one of, for example, the smart glasses 214 and the data processing apparatus 12. For example, the voice collection unit collects the partner's voice using the microphone 238 of the smart glasses 214 and transmits it to the specific processing unit 290 of the data processing apparatus 12. The facial expression collection unit captures the partner's facial expression using the camera 42 of the smart glasses 214 and transmits it to the specific processing unit 290 of the data processing apparatus 12. The analysis unit is implemented by the specific processing unit 290 of the data processing apparatus 12 and analyzes the voice data and facial expression data. The interpretation unit is implemented by the specific processing unit 290 of the data processing apparatus 12 and generates interpretation candidates based on the analysis results. The confidence evaluation unit is implemented by the specific processing unit 290 of the data processing apparatus 12 and evaluates the confidence of the interpretation candidates. The presentation unit displays the interpretation results using the display of the smart glasses 214. The voice guidance unit explains the interpretation results via audio using the speaker 240 of the smart glasses 214. The correspondence between each unit and the device or control unit is not limited to the above examples and various modifications are possible.

### Third Embodiment

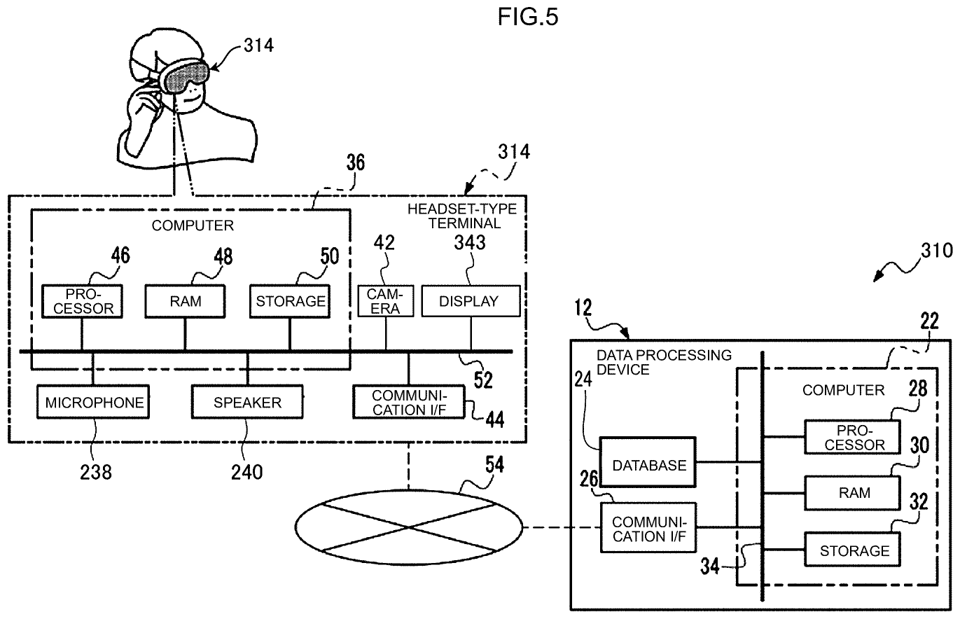

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

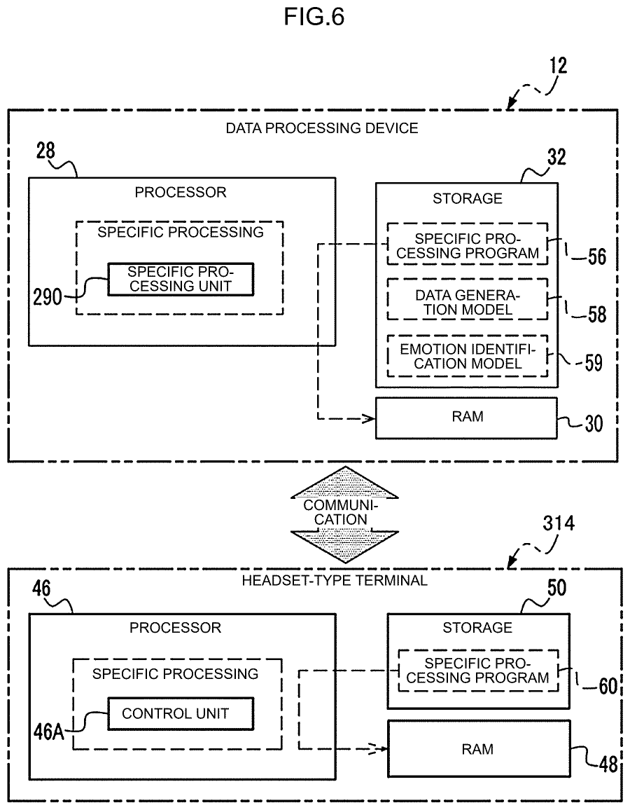

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the above-described elements, including the voice collection unit, facial expression collection unit, analysis unit, interpretation unit, confidence evaluation unit, presentation unit, and voice guidance unit, is implemented by at least one of, for example, the headset-type terminal 314 and the data processing apparatus 12. For example, the voice collection unit collects the partner's voice using the microphone 238 of the headset-type terminal 314 and transmits it to the specific processing unit 290 of the data processing apparatus 12. The facial expression collection unit captures the partner's facial expression using the camera 42 of the headset-type terminal 314 and transmits it to the specific processing unit 290 of the data processing apparatus 12. The analysis unit is implemented by the specific processing unit 290 of the data processing apparatus 12 and analyzes the voice data and facial expression data. The interpretation unit is implemented by the specific processing unit 290 of the data processing apparatus 12 and generates interpretation candidates based on the analysis results. The confidence evaluation unit is implemented by the specific processing unit 290 of the data processing apparatus 12 and evaluates the confidence of the interpretation candidates. The presentation unit displays the interpretation results using the display 343 of the headset-type terminal 314. The voice guidance unit explains the interpretation results via audio using the speaker 240 of the headset-type terminal 314. The correspondence between each unit and the device or control unit is not limited to the above examples and various modifications are possible.

### Fourth Embodiment

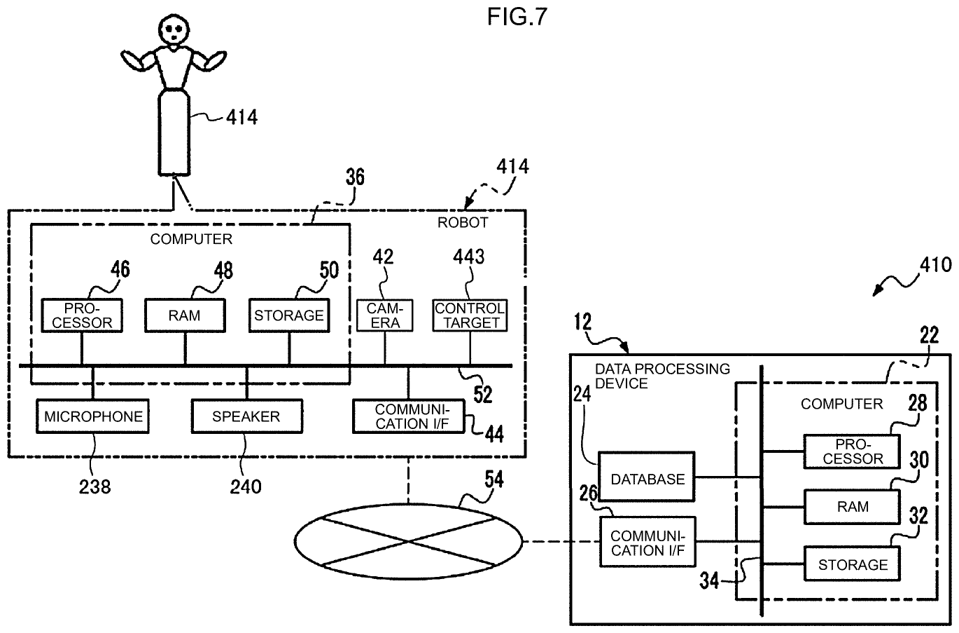

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

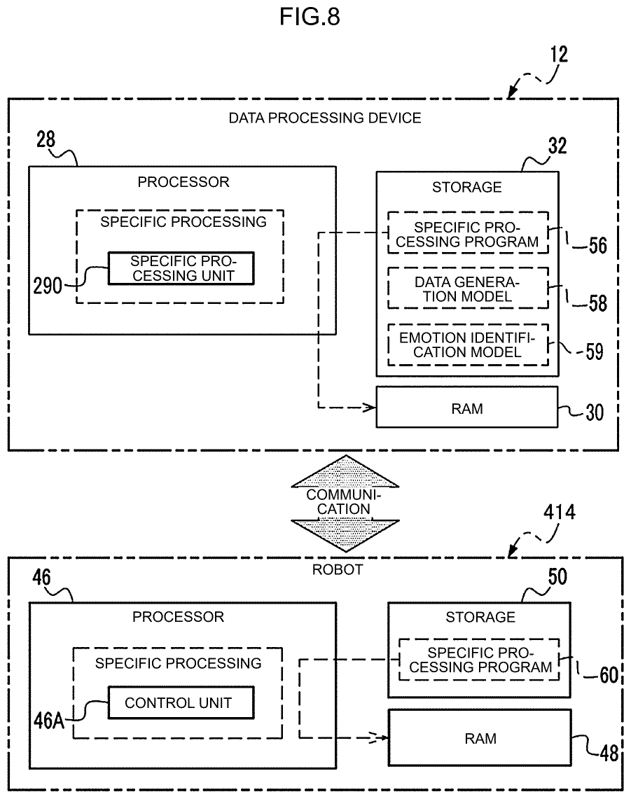

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the above-described elements, including the voice collection unit, facial expression collection unit, analysis unit, interpretation unit, confidence evaluation unit, presentation unit, and voice guidance unit, is implemented by at least one of, for example, the robot 414 and the data processing apparatus 12. For example, the voice collection unit collects the partner's voice using the microphone 238 of the robot 414 and transmits it to the specific processing unit 290 of the data processing apparatus 12. The facial expression collection unit captures the partner's facial expression using the camera 42 of the robot 414 and transmits it to the specific processing unit 290 of the data processing apparatus 12. The analysis unit is implemented by the specific processing unit 290 of the data processing apparatus 12 and analyzes the voice data and facial expression data. The interpretation unit is implemented by the specific processing unit 290 of the data processing apparatus 12 and generates interpretation candidates based on the analysis results. The confidence evaluation unit is implemented by the specific processing unit 290 of the data processing apparatus 12 and evaluates the confidence of the interpretation candidates. The presentation unit displays the interpretation results using the display of the robot 414. The voice guidance unit explains the interpretation results via audio using the speaker 240 of the robot 414. The correspondence between each unit and the device or control unit is not limited to the above examples and various modifications are possible.

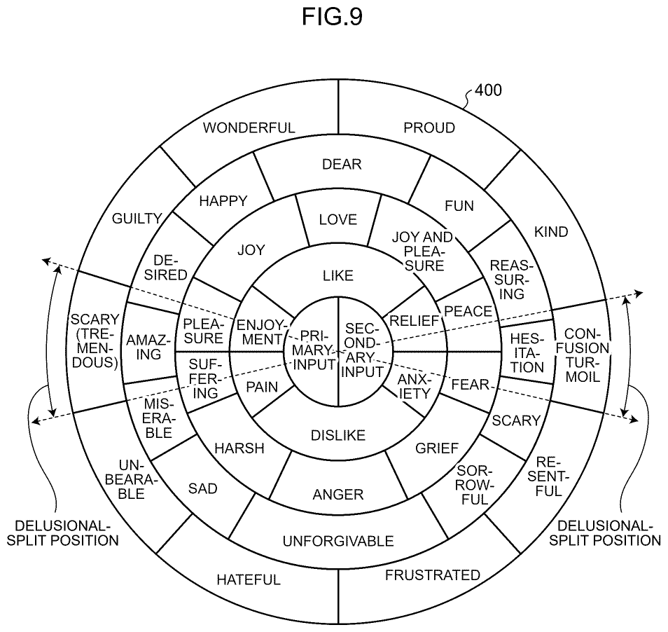

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

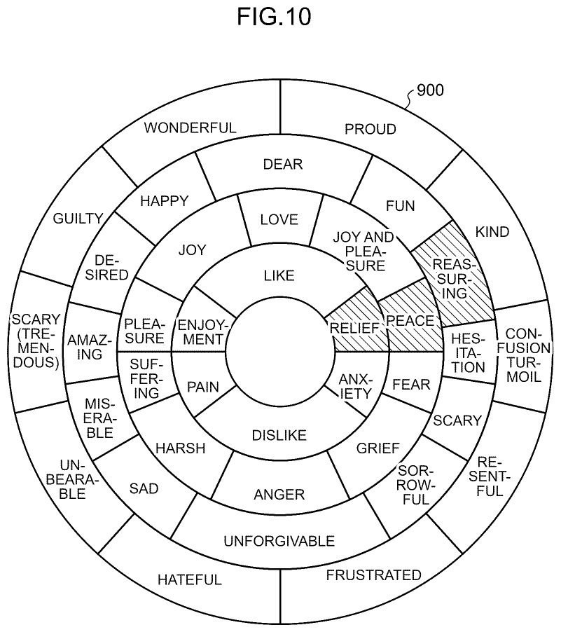

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

### [Additional Note 1]

A system comprising: a voice collection unit that collects voice data; a facial expression collection unit that collects facial expression data; an analysis unit that analyzes data collected by the voice collection unit and the facial expression collection unit; an interpretation unit that interprets the meaning and context of words based on the data analyzed by the analysis unit; a confidence evaluation unit that evaluates the confidence of the interpretation results obtained by the interpretation unit; a presentation unit that presents the interpretation results evaluated by the confidence evaluation unit to a smartphone; and a voice guidance unit that explains the interpretation results evaluated by the confidence evaluation unit via audio through earphones.

### [Additional Note 2]

The system according to Additional Note 1, wherein the voice collection unit collects the voice of a conversation partner during a conversation.

### [Additional Note 3]

The system according to Additional Note 1, wherein the facial expression collection unit captures the facial expressions of the conversation partner using a camera.

### [Additional Note 4]

The system according to Additional Note 1, wherein the analysis unit extracts the meaning and context of words from the voice data and analyzes emotions and intentions from the facial expression data.

### [Additional Note 5]

The system according to Additional Note 1, wherein the interpretation unit generates several interpretation candidates based on the data analyzed by the analysis unit.

### [Additional Note 6]

The system according to Additional Note 1, wherein the confidence evaluation unit evaluates the confidence of the interpretation candidates.

### [Additional Note 7]

The system according to Additional Note 1, wherein the presentation unit presents the interpretation results to the smartphone together with the confidence.

### [Additional Note 8]

The system according to Additional Note 1, wherein the voice guidance unit explains the interpretation results via audio through earphones.

### [Additional Note 9]

The system according to Additional Note 1, wherein the confidence evaluation unit analyzes the tone of the partner's voice and changes in facial expression to determine whether the partner is lying.

### [Additional Note 10]

The system according to Additional Note 1, wherein the voice collection unit estimates the user's emotion and adjusts the timing of voice collection based on the estimated emotion.

### [Additional Note 11]

The system according to Additional Note 1, wherein the voice collection unit filters ambient environmental sounds to remove noise during voice collection.

### [Additional Note 12]

The system according to Additional Note 1, wherein the voice collection unit analyzes the tone and speed of the partner's voice during voice collection to estimate emotions and intentions.

### [Additional Note 13]

The system according to Additional Note 1, wherein the voice collection unit estimates the user's emotion and determines the priority of the voice to be collected based on the estimated emotion.

### [Additional Note 14]

The system according to Additional Note 1, wherein the voice collection unit prioritizes the collection of relevant voice data by considering the user's geographic location during voice collection.

### [Additional Note 15]

The system according to Additional Note 1, wherein the voice collection unit analyzes the user's social media activity during voice collection and collects relevant voice data.

### [Additional Note 16]

The system according to Additional Note 1, wherein the facial expression collection unit estimates the user's emotion and adjusts the timing of facial expression collection based on the estimated emotion.

### [Additional Note 17]

The system according to Additional Note 1, wherein the facial expression collection unit uses a high-resolution camera to capture subtle facial movements during facial expression collection.

### [Additional Note 18]

The system according to Additional Note 1, wherein the facial expression collection unit individually analyzes the movements of each part of the face during facial expression collection.

### [Additional Note 19]

The system according to Additional Note 1, wherein the facial expression collection unit estimates the user's emotion and determines the priority of the facial expressions to be collected based on the estimated emotion.

### [Additional Note 20]

The system according to Additional Note 1, wherein the facial expression collection unit prioritizes the collection of relevant facial expressions by considering the user's geographic location during facial expression collection.

### [Additional Note 21]

The system according to Additional Note 1, wherein the facial expression collection unit analyzes the user's social media activity during facial expression collection and collects relevant facial expressions.

### [Additional Note 22]

The system according to Additional Note 1, wherein the analysis unit estimates the user's emotion and adjusts the analysis algorithm based on the estimated emotion.

### [Additional Note 23]

The system according to Additional Note 1, wherein the analysis unit improves analysis accuracy by considering the interrelationship between voice data and facial expression data during analysis.

### [Additional Note 24]

The system according to Additional Note 1, wherein the analysis unit optimizes the analysis algorithm by referring to past data during analysis.

### [Additional Note 25]

The system according to Additional Note 1, wherein the analysis unit estimates the user's emotion and adjusts the display method of analysis results based on the estimated emotion.

### [Additional Note 26]

The system according to Additional Note 1, wherein the analysis unit performs analysis by considering the geographic distribution of voice data and facial expression data during analysis.

### [Additional Note 27]

The system according to Additional Note 1, wherein the analysis unit improves analysis accuracy by referring to related literature during analysis.

### [Additional Note 28]

The system according to Additional Note 1, wherein the interpretation unit estimates the user's emotion and adjusts the interpretation algorithm based on the estimated emotion.

### [Additional Note 29]

The system according to Additional Note 1, wherein the interpretation unit improves interpretation accuracy by considering the interrelationship between voice data and facial expression data during interpretation.

### [Additional Note 30]

The system according to Additional Note 1, wherein the interpretation unit optimizes the interpretation algorithm by referring to past data during interpretation.

### [Additional Note 31]

The system according to Additional Note 1, wherein the interpretation unit estimates the user's emotion and adjusts the display method of interpretation results based on the estimated emotion.

### [Additional Note 32]

The system according to Additional Note 1, wherein the interpretation unit performs interpretation by considering the geographic distribution of voice data and facial expression data during interpretation.

### [Additional Note 33]

The system according to Additional Note 1, wherein the interpretation unit improves interpretation accuracy by referring to related literature during interpretation.

### [Additional Note 34]

The system according to Additional Note 1, wherein the confidence evaluation unit estimates the user's emotion and adjusts the confidence evaluation algorithm based on the estimated emotion.

### [Additional Note 35]

The system according to Additional Note 1, wherein the confidence evaluation unit improves the accuracy of confidence by considering the interrelationship between voice data and facial expression data during confidence evaluation.

### [Additional Note 36]

The system according to Additional Note 1, wherein the confidence evaluation unit optimizes the confidence evaluation algorithm by referring to past data during confidence evaluation.

### [Additional Note 37]

The system according to Additional Note 1, wherein the confidence evaluation unit estimates the user's emotion and adjusts the display method of confidence evaluation results based on the estimated emotion.

### [Additional Note 38]

The system according to Additional Note 1, wherein the confidence evaluation unit performs confidence evaluation by considering the geographic distribution of voice data and facial expression data during confidence evaluation.

### [Additional Note 39]

The system according to Additional Note 1, wherein the confidence evaluation unit improves the accuracy of confidence evaluation by referring to related literature during confidence evaluation.

### [Additional Note 40]

The system according to Additional Note 1, wherein the presentation unit estimates the user's emotion and adjusts the presentation method based on the estimated emotion.

### [Additional Note 41]

The system according to Additional Note 1, wherein the presentation unit adjusts the level of detail of the presentation based on the importance of the interpretation results during presentation.

### [Additional Note 42]

The system according to Additional Note 1, wherein the presentation unit applies different presentation algorithms according to the category of the interpretation results during presentation.

### [Additional Note 43]

The system according to Additional Note 1, wherein the presentation unit estimates the user's emotion and adjusts the length of the presentation based on the estimated emotion.

### [Additional Note 44]

The system according to Additional Note 1, wherein the presentation unit determines the priority of the presentation based on the submission timing of the interpretation results during presentation.

### [Additional Note 45]

The system according to Additional Note 1, wherein the presentation unit adjusts the order of the presentation based on the relevance of the interpretation results during presentation.

### [Additional Note 46]

The system according to Additional Note 1, wherein the voice guidance unit estimates the user's emotion and adjusts the expression method of the voice guidance based on the estimated emotion.

### [Additional Note 47]

The system according to Additional Note 1, wherein the voice guidance unit adjusts the level of detail of the guidance based on the importance of the interpretation results during voice guidance.

### [Additional Note 48]

The system according to Additional Note 1, wherein the voice guidance unit applies different guidance algorithms according to the category of the interpretation results during voice guidance.

### [Additional Note 49]

The system according to Additional Note 1, wherein the voice guidance unit estimates the user's emotion and adjusts the length of the voice guidance based on the estimated emotion.

### [Additional Note 50]

The system according to Additional Note 1, wherein the voice guidance unit determines the priority of the guidance based on the submission timing of the interpretation results during voice guidance.

### [Additional Note 51]

The system according to Additional Note 1, wherein the voice guidance unit adjusts the order of the guidance based on the relevance of the interpretation results during voice guidance.

What is claimed is:

1. A system comprising: a voice collection unit that collects voice data; a facial expression collection unit that collects facial expression data; an analysis unit that analyzes data collected by the voice collection unit and the facial expression collection unit; an interpretation unit that interprets the meaning and context of words based on the data analyzed by the analysis unit; a confidence evaluation unit that evaluates the confidence of the interpretation results obtained by the interpretation unit; a presentation unit that presents the interpretation results evaluated by the confidence evaluation unit to a smartphone; and a voice guidance unit that explains the interpretation results evaluated by the confidence evaluation unit via audio through earphones.

2. The system according to claim 1, wherein the voice collection unit collects the voice of a conversation partner during a conversation.

3. The system according to claim 1, wherein the facial expression collection unit captures the facial expressions of the conversation partner using a camera.

4. The system according to claim 1, wherein the analysis unit extracts the meaning and context of words from the voice data and analyzes emotions and intentions from the facial expression data.

5. The system according to claim 1, wherein the interpretation unit generates several interpretation candidates based on the data analyzed by the analysis unit.

6. The system according to claim 1, wherein the confidence evaluation unit evaluates the confidence of the interpretation candidates.

7. The system according to claim 1, wherein the presentation unit presents the interpretation results to the smartphone together with the confidence.

8. The system according to claim 1, wherein the voice guidance unit explains the interpretation results via audio through earphones.
